(19) United States
(12) Patent Application Publication
(10) Pub. No.: US 2009/0120796 A1
(43) Pub. Date: May 14, 2009

(54) ELECTROKINETIC CONCENTRATION DEVICE AND METHODS OF USE THEREOF

(76) Inventors: Jongyoon Han, Bedford, MA (US); Yong-Ak Song, Newton, MA (US); Jeong Hoon Lee, Seoul (KR)

Correspondence Address: Pearl Cohen Zedek Latzer, LLP, 1500 Broadway, 12th Floor, New York, NY, 10036, US

(21) Appl. No.: 12/239,438

(22) Filed: Sep. 26, 2008

Related U.S. Application Data
(60) Provisional application No. 60/960,363, filed on Sep. 26, 2007.
(60) Provisional application No. 60/960,417, filed on Sep. 28, 2007.

(51) Int. Cl. B01D 69/10; G01N 1/40

(52) U.S. Cl. 204/518; 204/627; 427/2.11

(57) ABSTRACT

The present invention provides a device and methods of use thereof in concentrating a species of interest and/or controlling liquid flow in a device. The methods, inter-alia, make use of a device comprising a fluidic chip comprising a planar array of channels through which a liquid comprising a species of interest can be made to pass with at least one rigid substrate connected thereto such that at least a portion of a surface of the substrate bounds the channels, and an ion-selective membrane is attached to at least a portion of the surface of the substrate, which bounds said channels, or which bounds a portion of a surface of one of said channels. The device comprises a unit to induce an electric field in the channel and a unit to induce an electrokinetic or pressure driven flow in the channel.

### CROSS-REFERENCE TO RELATED APPLICATIONS

This Application claims priority of U.S. Provisional Application Ser. No. 60/960,363, filed Sep. 26, 2007, and U.S. Provisional Application Ser. No. 60/960,417, filed Sep. 28, 2007 which are hereby incorporated by reference, it their entirety.

### GOVERNMENT INTEREST STATEMENT

This invention was made in whole or in part with government support under R01-EB005743 awarded by the National Institutes of Health and under CTS-0347348 awarded by the National Science Foundation. The government may have certain rights in the invention.

### FIELD OF THE INVENTION

This invention provides devices and methods of use thereof in concentrating a charged species of interest in solution. This invention provides a concentration device, which is based on electrokinetic trapping of a charged species of interest, which can be further isolated and analyzed.

### BACKGROUND OF THE INVENTION

One of the major challenges of proteomics is the sheer complexity of biomolecule samples, such as blood serum or cell extract. Typical blood samples could contain more than 10,000 different protein species, with concentrations varying over 9 orders of magnitude. Such diversity of proteins, as well as their huge concentration ranges, poses a formidable challenge for sample preparation in proteomics.

Conventional protein analysis techniques, based on multidimensional separation steps and mass spectrometry (MS), fall short because of the limited separation peak capacity (up to ˜3000) and dynamic range of detection (˜10⁴). Microfluidic biomolecule analysis systems (so-called μTAS) hold promise for automated biomolecule processing. Various biomolecule separation and purification steps, as well as chemical reaction and amplification have been miniaturized on a microchip, demonstrating orders of magnitude faster sample separation and processing. In addition, microfluidic integration of two different separation steps into a multidimensional separation device has been demonstrated. However, most microfluidic separation and sample processing devices suffers from the critical issue of sample volume mismatch. Microfluidic devices are very efficient in handling and processing 1 pL˜1 nL of sample fluids, but most biomolecule samples are available or handled in a liquid volume larger than 1 μL. Therefore, microchip-based separation techniques often analyze only a small fraction of available samples, which significantly limits the overall detection sensitivity. In proteomics, this problem is exacerbated by the fact that information-rich signaling molecules (cytokines and biomarkers, e.g.) are present only in trace concentrations (nM˜pM range), and there is no signal amplification technique such as polymerase chain reaction (PCR) for proteins and peptides.

What is needed is an efficient sample concentrator, which can take typical sample volume of microliters or more and concentrate molecules into a smaller volume so that it can be separated and detected much more sensitively. Several strategies are currently available to provide sample preconcentration in liquid, including field-amplified sample stacking (FAS), isotachophoresis (ITP), electrokinetic trapping, micellar electrokinetic sweeping, chromatographic preconcentration, and membrane preconcentration. Many of these techniques are originally developed for capillary electrophoresis, and require special buffer arrangements and/or reagents. Efficiency of chromatographic and filtration-based preconcentration techniques depends on the hydrophobicity and the size of the target molecules.

Electrokinetic trapping is another means for such charged biomolecule concentration. When applying an electric field across an ion-selective membrane, a charge-depletion region is developed, which in combination with tangential flow (either pressure-driven or electroosmosis-driven), can concentrate the charged analytes inside a channel. Currently, however, the fabrication of such devices is cumbersome and complex, since the integration of sufficiently thin (˜5 um) ion-selective membranes into the device has been challenging. Thin Nafion membranes are easily breakable and handling requires extreme care since the membrane can be easily wrapped around itself, confounding planar device fabrication methods.

Another attempt at planar devices sandwiched a thin ion-selective membrane between two planar microchips, each chip containing a microchannel, however this led to imperfect sealing of the device, resulting in gap formation around the membrane and thereby current leakage.

### SUMMARY OF THE INVENTION

The invention provides, in one embodiment, a concentrating device comprising:
a fluidic chip comprising a planar array of channels through which a liquid comprising a species of interest can be made to pass;
at least one rigid substrate connected thereto such that at least a portion of a surface of said substrate bounds said channels;
an ion-selective membrane attached to at least a portion of said surface of said substrate, which bounds said channels; or
an ion-selective membrane which bounds a portion of a surface of one of said channels;
a unit to induce an electric field in said channel; and
a unit to induce an electrokinetic or pressure driven flow in said channel.

In one embodiment, the means for inducing an electric field in the channel is a voltage supply, which in some embodiments is supplied at between 50 mV and 1500 V. In one embodiment, the voltage supply applies equal voltage to opposing sides of said microchannels, or in another embodiment, the voltage supply applies greater voltage to one channel, as compared to another channel, or in another embodiment, the voltage supply causes a potential difference between one area of said microchannel, as compared to another area within said microchannel. In another embodiment the voltage supply creates a potential difference between at least two said channels.

In some embodiments, the width of the channel is between about 10-200 μm, and in some embodiments, the width of the channel is between about 10 μm-50 μm. In some embodiments the depth of the channel is between about 5-50 μm, and in some embodiments, the depth of the channel is between about 5-10 μm. In some embodiments, the ion-selective membrane has a width of between about 50-1000 μm, and in some embodiments, the width of the ion-selective membrane is 100-500 μm. In some embodiments, the ion-selective membrane has a depth of between about 100-500 nm, and in some embodiments, the depth of the ion-selective membrane is between about 10-50 μm and in some embodiments, the depth of the ion-selective membrane is between about 5-20 μm.

In some embodiments, the rigid substrate comprises pyrex, silicon, silicon dioxide, silicon nitride, quartz, PMMA, PC or acryl.

In one embodiment, the fluidic chip comprises polydimethylsiloxane.

In one embodiment, the ion-selective membrane comprises polytetrafluoroethylenes (PTFEs), perfluorosulfonates, polyphosphazenes, polybenzimidazoles (PBIs), poly-zirconia, polyethyleneimine-poly(acrylic acid), poly(ethylene oxide)-poly(acrylic acid), or non-fluorinated hydrocarbon polymers or polymer-inorganic composites. In some embodiments, the ion-selective membrane has a thickness of about between 100-500 nm and in other embodiments the ion-selective membrane has a thickness of about between 5-20 μm.

In some embodiments, the surface of the microchannel has been functionalized to reduce or enhance adsorption of said species of interest to said surface, or in some embodiments, the surface of the microchannel has been functionalized to enhance or reduce the operation efficiency of the device.

In some embodiments, the unit to induce an electric field in the channel comprises at least a pair of electrodes and a power supply. In some embodiments, the substrate comprises electrodes, which are positioned proximally to the ion-selective membrane.

In some embodiments, the device is coupled to a separation system, detection system, analysis system or combination thereof. In some embodiments, the device is coupled to a mass spectrometer.

In one embodiment, this invention provides a microfluidic pump comprising a device of this invention, which in one embodiment has a liquid flow speed of between 10 μm/sec and 10 mm/sec.

In one embodiment, the invention provides for a method of concentrating a species of interest in a liquid, the method comprising applying a liquid comprising the species of interest to the devices of this invention.

In one embodiment, the method further comprises the steps of:
inducing an electric field in the channel whereby ion depletion occurs in a region in the channel proximal to the ion-selective membrane, and a space charge layer is formed within the channel, which provides an energy barrier to said species of interest; and
inducing liquid flow in the channel.

In one embodiment, the flow is electroosmotic, or in another embodiment, the flow is pressure driven.

In one embodiment, the steps are carried out cyclically.

In one embodiment, inducing an electric field in said channel is by applying voltage to said device, which in one embodiment is between 50 mV and 1500 V. In one embodiment, equal voltage is applied to opposing sides of the channel, or in another embodiment, greater voltage is applied to the anodic side of the channel, as compared to the cathodic side.

In one embodiment, a space charge layer is generated in the channel prior to applying greater voltage to the anodic side of said channel.

In one embodiment, the liquid comprises an organ homogenate, cell extract or blood sample. In another embodiment, the species of interest comprises proteins, polypeptides, nucleic acids, viral particles, or combinations thereof. In one embodiment, the species of interest comprises micro- and/or nanoparticles.

According to this aspect of the invention and in another embodiment, the device is coupled to a separation system, detection system, analysis system or combination thereof.

In some embodiments, this invention provides a method for the preparation of a concentrating device comprising:
a fluidic chip comprising a planar array of channels through which a liquid comprising a species of interest can be made to pass;
at least one rigid substrate connected thereto such that at least a portion of a surface of said substrate bounds said channels; and
an ion-selective membrane bonded to at least a portion of said surface of said substrate, which bounds said channels;
the method comprising
applying a liquid polymer to a rigid substrate under negative pressure wherein said substrate is connected to a fluidic chip comprising channels such that said channels bound at least a portion of a surface of said substrate and whereby said polymer is applied for a time sufficient to form a layer of said polymer on a surface of said substrate;
providing conditions such that said liquid polymer layer forms a membranous structure on a surface of said substrate; and
attaching said substrate to said fluidic chip comprising channels such that said channels bound at least a portion of a surface of said substrate comprising said membranous structure.

In some embodiments, the liquid polymer comprises polytetrafluoroethylenes, polyphosphazenes, polybenzimidazoles (PBIs), poly-zirconia, polyethyleneimine-poly(acrylic acid), or poly(ethylene oxide)- poly(acrylic acid).

In some embodiments, the membranous structure has a thickness of 100-500 nm and in some embodiments the ion selective membrane has a thickness of 5-20 μm. In some embodiments, the ion selective membrane has a thickness of 20-80 μm, or in some embodiments, 50-100 μm, or in some embodiments, 150-300 μm, or in some embodiments, 250-500 μm. In one embodiment, providing conditions such that the liquid polymer layer forms a membranous structure on a surface of the substrate is accomplished by heating the substrate. In one embodiment, attaching the substrate to the fluidic chip is by plasma bonding.

In another embodiment, this invention provides a method for the preparation of a concentrating device comprising:
a fluidic chip comprising a planar array of channels through which a liquid comprising a species of interest can be made to pass;
at least one rigid substrate connected thereto such that at least a portion of a surface of said substrate bounds said channels; and
an ion-selective membrane bonded to at least a portion of said surface of said substrate, which bounds said channels;
said method comprising
stamping a liquid polymer on a rigid substrate in a desired geometry, pattern or a combination thereof, whereby said polymer is applied for a time sufficient to form a layer of said polymer on a surface of said substrate;
providing conditions such that said liquid polymer layer forms a membranous structure on a surface of said substrate; and
attaching said substrate to a fluidic chip comprising channels such that said channels bound at least a portion of a surface of said substrate comprising said membranous structure.

In some embodiments, the thickness of the membranous structure may be enhanced by increasing the viscosity of the liquid polymer. In another embodiment, the thickness of the membranous structure may be enhanced by using a hydrophobic stamper for the stamping. In another embodiment, the stamping is accomplished with a stamper comprising polydimethylsiloxane.

In some embodiments, the liquid polymer comprises polytetrafluoroethylenes, polyphosphazenes, polybenzimidazoles (PBIs), poly-zirconia, polyethyleneimine-poly(acrylic acid), or poly(ethylene oxide)-poly(acrylic acid).

In some embodiments, the membranous structure has a thickness of 100-500 nm and in some embodiments the ion selective membrane has a thickness of 5-20 μm. In some embodiments, providing conditions such that the liquid polymer layer forms a membranous structure on a surface of the substrate is accomplished by heating the substrate.

In some embodiments, attaching the substrate to the fluidic chip is by plasma bonding.

In some embodiments, this invention provides a method for the preparation of a concentrating device comprising:
a fluidic chip comprising a planar array of channels through which a liquid comprising a species of interest can be made to pass;
at least one rigid substrate connected thereto such that at least a portion of a surface of said substrate bounds said channels; and
a high aspect ratio ion-selective membrane which bounds a portion of a surface of one of said channels;
   said method comprising:
applying a liquid polymer to at least a portion of one of said channels whereby said polymer is applied for a time sufficient to form a layer of said polymer on a portion of a surface of one of said channels; and
providing conditions such that said liquid polymer layer forms a membranous structure;

In some embodiments, the liquid polymer comprises microbeads, which are infiltrated with the liquid polymer. In one embodiment, these microbeads act as a supporting solid matrix and increase the mechanical strength of the ion-selective membrane. In some embodiments, the liquid polymer is liquid Nafion.

### BRIEF DESCRIPTION OF THE DRAWINGS

FIG. 1 schematically depicts embodiments of methods for fabricating the devices of the invention.

FIG. 2 is a photograph of an embodiment of a device of the invention, which was fabricated by a method comparable to that outlined in FIG. 1.

FIG. 3 depicts an embodiment of a concentration device of this invention and a process for the fabrication of the same. FIG. 3a shows the formation of the Nafion nano-bridge using capillary lithography on the glass substrate; FIG. 3b shows the bonding between PDMS (microchannels) and Nafion nano-bridge on glass; FIG. 3c describes the preconcentrator chip including the PDMS and the Nafion bridge on glass. Electrode contacts are shown.

FIG. 4 depicts an embodiment of the mechanism of concentration of the charged species in the device of FIG. 2. In the trapping mode, the injected sample is trapped with an applied potential difference V_{diff}=200V across the Nafion membrane and with a pressure-driven flow. If the desired preconcentration factor is reached, a buffer solution is injected with an autosampler to adjust the pH value of the sample to the pI value of the trapped molecules. B) Once the pH value reaches the pI value of the molecules, the molecules become neutral and are released from the electrokinetic trap. To switch to the dispensing mode, the voltage configuration is changed, which can be accomplished with a high voltage sequencer. The voltage in the middle channel is increased to ˜1000V to achieve a droplet generation from the channel to the MALDI plate. In order to retain the buffer ions in the channel (otherwise the dispensed sample would have a high salt concentration), the depletion region is further maintained in the dispension mode. Therefore, the same potential difference, Vdiff=200V (1000V−800V), is constantly applied across the main and the two side channels while dispensing the released molecules from the end of the middle channel. To remove the waste before dispensing the sample, an air jet positioned near the orifice may be used. If the MALDI plate is mounted on an X-Y table, successive collection of additional samples on the plate may be accomplished.

FIG. 5 depicts one embodiment of the pre-concentrator operating scheme. FIG. 5a. illustrates the “capture” or trapping mode wherein the two sides of the sample channel are held at a constant 50V vs. the buffer channel which is grounded. At this voltage configuration, charged particles will be trapped around the Nafion membrane bridge (shown); FIG. 5b shows the release or dispensing mode. In this mode the voltage at one end of the sample channel is reduced to 25V creating a 25V potential difference between the two ends of the sample channel. This potential difference causes particle flow; FIG. 5c is an image of the location of the biological marker at stages a (top) and b (bottom).

FIG. 6 is a plot of β-phycoerythrin preconcentration (in units of fluorescence intensity) vs. electrokinetic trapping time. A pre-concentration factor of ˜10⁵ in 20 min (10⁴ in 5 min) was achieved in this embodiment. Fluorescence images of 4 nM protein shown next to the graph indicate an increase of the concentrated plug size and concentration as a function of increasing trapping time. The data are shown for 10 mM phosphate buffer, pH=7 solution.

FIG. 7 depicts one embodiment of the device operation as a reaction boosting tool for low-abundance enzymes.

FIG. 8 describes an embodiment of the trapping and assay of a compound in a microchannel, where the assay is an enzymatic assay.

FIG. 9 plots the fluorescence signal intensity of products formed in a device, which was not operated in the concentration mode, in an enzymatic processing assay.

FIG. 10 plots fluorescence signal intensity of product formation of the assay in FIG. 9, when the device is operated in the concentration mode.

FIG. 11a depicts one embodiment of the device, wherein the Nafion membrane has a high aspect ratio. Top view (left) and side view (right) of the high aspect ratio Nafion membrane is shown. In the process shown, the Nafion membrane is formed by first introducing Nafion resin into a trench in the glass. The trench is formed with the desired membrane dimensions. The electrolyte is cured. Other permeable materials such as Nafion can be added to the electrolyte material. Any other perm-selective polymer materials such as hydrogel can be used instead. Bonding of PDMS structure that include microchannels is carried out on top of the high-aspect-ratio ion-selective membrane. In another embodiment, a trench is patterned in the PDMS chip (in the form of a micro/nanochannel) and is filled with Nafion, as shown in FIG. 11b.

FIG. 12 schematically depicts a parallel array of 16 pre-concentrator devices, indicating sample and buffer loading ports and areas of expected plug formation in the devices.

FIG. 13 schematically depicts an embodiment of integration of the concentrator for use in mass spectroscopy.

FIG. 14 schematically depicts an embodiment of a PDMS preconcentrator with surface-patterned Nafion membrane on the glass substrate and its operation. (b) Au dot array (diameter=20 μm) on glass slide for the application of immunoassay. The middle channel is loaded with hcG protein (in PBS) and the side channel is filled with a 1×PBS buffer solution. For preconcentration, a potential difference is applied across the middle and the side channels in combination with an electrokinectic flow. All the microchannels were 12 μm deep and 70 μm wide.

FIG. 15 schematically depicts an embodiment of hcG protein immobilization via the formation of alkylthiolate self-assembled monolayers on Au surface. (a) Formation of Tri(ethylene glycol) dodecylthiol (TEG) and Biotinylated tri(ethylene glycol) dodecylthiol (BAT) on Au surface. (b) binding of streptavidin (c) binding of biotinated monoclonal anti-hcG, (d) surface blocking using BSA (1% in PBS) for preventing non-specific binding. (e) Immunoassay using hcG protein (Human Chorionic Gonadotropin (HCG), Fitzgerald Inc, MA) labeled with Alexa488.

FIG. 16 depicts an embodiment of: (a) Operation of preconcentration of cy3 labeled streptavidin onto biotinylated Au surface (after 10 min, 10 ug/mL streptavidin in 1×PBS; V1=50V and V2=25V, V3=V4=GND) (b) Fluorescence image after washing step (by Injection of PBS/PBST (PBS with Tween20)/PBS). Images taken from blue dot area in (a) after washing step. (c) Fluorescence intensity of each Au dot indicates dramatically improving binding kinetics in preconcentration zone.

FIG. 17 depicts an embodiment of: (a) Optical image of the PDMS protein preconcentration chip. Surface patterned Nafion membrane was located between Au dot. (b) Operation of preconcentration (after 10 min, 1 ug/mL bBE in 1×PBS; with 1 mg/mL BSA background protein; V1=50V and V2=25V, V3=V4=GND), showing stable operation of preconcentration as well as no non-specific binding event between immobilized anti-hcG and bPE protein (image not shown). Fluorescence image and intensity profile of (c) Preconcentration of hcG protein (taken after 10 min preconcentration, 500 ng/mL hcG antigen in 1×PBS; with 1 mg/mL BSA background protein; V1=50V and V2=25V, V3=V4=GND) (using same device after washing step of device b). (d) Fluorescence image and intensity profile after washing step of device c, showing the enhancement of binding kinetics between hcG Ag-Ab via preconcentration.

FIG. 18 schematically depicts an embodiment of an alternative fabrication method of the ion-selective membrane junctions inside the microchannel; a) Filling the buffer channels [18-20] with Nafion resin. Sample channel [18-10] is the middle channel. The sample channel is connected to the buffer channels through the pre-patterned micro junctions. Micro junctions [18-30] are 10-50 μm wide, 20-50 μm long; b) Flushing the Nafion resin by applying negative pressure on the buffer channels; c) Creation of the Nafion membrane junctions after a complete removal of the excessive Nafion resin. Nafion membrane junctions [18-40] are depicted; d) Concentrator in operation.

### DETAILED DESCRIPTION OF THE INVENTION

This invention provides, in one embodiment, a concentrating device and methods of use thereof, in concentrating a species of interest.

In some embodiments, this invention provides devices for concentration and/or pre-concentration of a substance on a micro- or nano-scale. The devices of this invention, in some embodiments, make use of ion-selective membranes such as Nafion membranes, placed in microfluidic chips, through a unique fabrication process, which enables, in some embodiments, specific deposit of the ion-selective membrane in a planar device, in a manner, which is inexpensive and promotes ready deposition despite the known fragility of such membranes to physical manipulations, which in the past made their incorporation into such devices difficult.

In some embodiments, the devices and methods of this invention entail patterning resin solutions and curing such solutions to form the ion selective membranes, as herein described. In some embodiments, patterning the resin solution enables thin planar membrane patterning on a substrate, and incorporation of the same in a microchannel of a device, via e.g. plasma bonding a PDMS channel on top of it.

The invention provides, in one embodiment, a concentrating device comprising:
a fluidic chip comprising a planar array of channels through which a liquid comprising a species of interest can be made to pass;
at least one rigid substrate connected thereto such that at least a portion of a surface of said substrate bounds said channels;
an ion-selective membrane attached to at least a portion of said surface of said substrate, which bounds said channels; or
an ion-selective membrane which bounds a portion of a surface of one of said channels;
a unit to induce an electric field in said channel; and
a unit to induce an electrokinetic or pressure driven flow in said channel.

In some embodiments, this invention provides a method for the preparation of a concentrating device comprising:
a fluidic chip comprising a planar array of channels through which a liquid comprising a species of interest can be made to pass;
at least one rigid substrate connected thereto such that at least a portion of a surface of said substrate bounds said channels; and
an ion-selective membrane bonded to at least a portion of said surface of said substrate, which bounds said channels;
the method comprising
applying a liquid polymer to a rigid substrate under negative pressure wherein said substrate is connected to a fluidic chip comprising channels such that said channels bound at least a portion of a surface of said substrate and whereby said polymer is applied for a time sufficient to form a layer of said polymer on a surface of said substrate;
providing conditions such that said liquid polymer layer forms a membranous structure on a surface of said substrate; and
attaching said substrate to said fluidic chip comprising channels such that said channels bound at least a portion of a surface of said substrate comprising said membranous structure.

According to this aspect of the invention, and in one embodiment, this invention provides a device fabricated according to the preceding method.

In some embodiments, the liquid polymer comprises polytetrafluoroethylenes, polyphosphazenes, polybenzimidazoles (PBIs), poly-zirconia, polyethyleneimine-poly(acrylic acid), or poly(ethylene oxide)-poly(acrylic acid). In one embodiment, the liquid polymer may comprise any type of ion-selective polymer and/or ion-selective material.

In some embodiments, the membranous structure has a thickness of 100-500 nm and in some embodiments the ion selective membrane has a thickness of 5-20 μm. In one embodiment, providing conditions such that the liquid polymer layer forms a membranous structure on a surface of the substrate is accomplished by heating the substrate. In one embodiment, attaching the substrate to the fluidic chip is by plasma bonding.

In another embodiment, this invention provides a method for the preparation of a concentrating device comprising:
a fluidic chip comprising a planar array of channels through which a liquid comprising a species of interest can be made to pass;
at least one rigid substrate connected thereto such that at least a portion of a surface of said substrate bounds said channels; and
an ion-selective membrane bonded to at least a portion of said surface of said substrate, which bounds said channels;
said method comprising
stamping a liquid polymer on a rigid substrate in a desired geometry, pattern or a combination thereof, whereby said polymer is applied for a time sufficient to form a layer of said polymer on a surface of said substrate;
providing conditions such that said liquid polymer layer forms a membranous structure on a surface of said substrate; and
attaching said substrate to a fluidic chip comprising channels such that said channels bound at least a portion of a surface of said substrate comprising said membranous structure.

According to this aspect of the invention, and in one embodiment, this invention provides a device fabricated according to the preceding method, or in some embodiments, according to any method described, diagrammed or depicted or exemplified herein.

In some embodiments, the thickness of the membranous structure may be enhanced by increasing the viscosity of the liquid polymer. In another embodiment, the thickness of the membranous structure may be enhanced by using a hydrophobic stamper for the stamping. In another embodiment, the stamping is accomplished with a stamper comprising polydimethylsiloxane.

In some embodiments, the liquid polymer comprises polytetrafluoroethylenes, polyphosphazenes, polybenzimidazoles (PBIs), poly-zirconia, polyethyleneimine-poly(acrylic acid), or poly(ethylene oxide)-poly(acrylic acid).

In some embodiments, the membranous structure has a thickness of 100-500 nm and in some embodiments the ion selective membrane has a thickness of 5-20 μm. In some embodiments, providing conditions such that the liquid polymer layer forms a membranous structure on a surface of the substrate is accomplished by heating the substrate.

In some embodiments, attaching the substrate to the fluidic chip is by plasma bonding.

In some embodiments, the invention provides various methods for patterning an ion-selective membrane on a rigid substrate, to form the devices of this invention. Such methods are described herein, and exemplified in example 1 hereinbelow.

In some embodiments, the patterning methods of this invention, and devices made thereby comprise, inter alia, flowing a resin through a micro- or nano-channel in a device under negative pressure, flushing the resin, and curing the adhered thin layer which in turn forms a planar membrane structure. In some embodiments, the viscosity of the resin is varied, or in some embodiments, the pressure applied is varied, which in turn will affect the thickness of the membrane formed thereby.

In some embodiments, the patterning methods of this invention, and devices made thereby comprise, inter alia, micro- or nano-stamping liquid resin transferred onto a substrate via stamping techniques, as will be appreciated by one skilled in the art. In some embodiments, the resin viscosity is varied, or n some embodiments, the hydrophobicity of the resin is varied, to affect the subsequent thickness of the ion-selective membrane formed thereby.

In some embodiments, the patterning methods of this invention, and devices made thereby comprise, inter alia, ink jet printing of the resin on the substrate, where the pattern of deposition can readily be varied as a function of the printing In some embodiments, the patterning methods of this invention, and devices made thereby comprise, inter alia, UV lithography or e-beam lithography of the resin on a substrate, for example a polymer or glass substrate.

In some embodiments, the methods for producing planar micro- or nano-fluidic devices with high-aspect-ratio, ion-selective membranes of this invention, may comprise, inter alia, use of two oppositely charged polyelectrolytes such as PSS/PAA, which acts as a supporting solid matrix. In one embodiment, microbeads or any type of colloidal particles can be used as alternative materials to PSS/PAA to build a high-aspect-ratio supporting solid matrix. Ion selectivity may then be imparted to the supporting matrix by infiltrating the membrane with a resin, which imparts such properties, for example, infiltrating the membrane with Nafion resin. According to this aspect of the invention and in one embodiment, due to the capillary force of the membrane, the pores of the polyelectrolyte membrane fill with the Nafion resin imparting to the membrane ion perm-selectivity. In some embodiments, removing excess Nafion resin residue from the channel is accomplished by flushing the channel with deionized water.

It is to be understood that any liquid resin, which when patterned and cured according to the methods as described herein, produces an ion-selective membrane is to be considered as part of this invention, and the invention is not to be limited to the examples of constituents of such resins as herein described.

In some embodiments, such membranes can be constructed so as to comprise a perfluorosulfonated membrane comprised of a polytetrafluoroethylene(PTFE)-crosslinked hydrophobic backbone impregnated with hydrophilic sulfonic acid sites. In some embodiments, hydrocarbon polymer non-fluorinated, and polymer-inorganic composite membranes can be similarly prepared, and used in the methods of this invention.

In some embodiments, the membranes/resins will comprise polymers such as polyphosphazenes, polybenzimidazoles (PBIs), and/or zirconia-polymer gels.

In some embodiments, polyelectrolyte multilayer systems such as LPEI/PAA or PEO/PAA (LPEI: linear polyethyleneimine, PAA: poly(acrylic acid); PEO: poly(ethylene oxide)) may be used. In some embodiments, films constructed from LPEI and PAA exhibit an ionic conductivity as high as 10⁻⁵ S/cm⁻¹ at 100% relative humidity and room temperature, and thus are useful in the devices of this invention.

In some embodiments, a membrane of PEO and PAA can be constructed via hydrogen-bonding interactions, films with conductivities from 10⁻⁵ to as high as 10⁻⁴ S/cm⁻¹ at ambient conditions may be obtained. In some embodiments, the method comprising flowing a resin through a micro- or nano-channel in a device under negative pressure, flushing the resin, and curing the adhered thin layer is useful for producing the desired ion-selective membrane in the devices of this invention, using polyelectrolyte multilayers as described hereinabove.

In some embodiments, unique to the methods and devices of this invention is the absence of a requirement for the physical manipulation of fragile membranes in order to integrate such membranes into the devices of this invention. In some embodiments, the invention comprises processes for patterning/depositing a resin on a rigid substrate followed by curing of the resin to form a membrane, which in turn may be readily integrated in the device without further physical manipulation of the formed membrane. In some embodiments, the devices of this invention and processes for preparing the same comprise curing an ion-selective resin to form the membrane, as part of the construction of the device, and makes use of materials which are disposable, thus providing a simply manufactured device, which can readily be mass produced, to form arrays of parallel concentrators on a medium that can be disposable.

In one embodiment, this invention provides surface treatment of a glass substrate prior to Nafion patterning as described herein below. Severe degradation of planar Nafion membranes can occur especially when a highly concentrated buffer solution such as PBS 1× is used inside the microfluidic concentrator device. A possible reason for this result is that the Na⁺ ion attacks the interface between the glass substrate and the Nafion membrane with increasing concentration. The Nafion membrane may fall off from the substrate completely during the operation and the device might stop working. In one embodiment, this invention provides an effective surface treatment method that increases the bonding strength between the glass substrate and the Nafion membrane. First, a Sylgard Prime Coat solution is patterned the on a glass substrate. In one embodiment, such patterning enhances the adhesion and bonding of silicones to a variety of substrates and aids in the penetration of the active ingredients into the bonding surface. After depositing the Prime Coat layer on the substrate, a Nafion resin is patterned using various patterning methods as described previously. In this way, the bonding strength is increased and a concentration of the protein sample could be accomplished even in high ionic strength media such as PBS 1×.

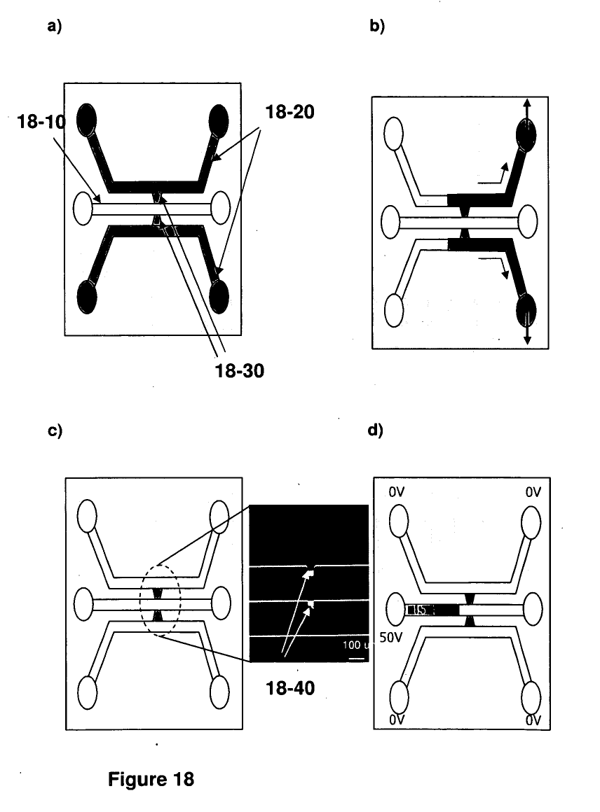

In one embodiment, this invention provides an alternative fabrication method for making a perm-selective junction. In one embodiment, instead of creating a planar ion-selective junction between the sample and side buffer channels by patterning the Nafion resin as disclosed herein above, an alternative way of creating an ion-selective membrane between the microchannels was developed. Using this fabrication method, a high-aspect-ratio ion-selective membrane can be fabricated for enhanced sample preconcentration. The capillary-force-based filling method is shown in FIG. 18.

Initially, the Nafion resin is flown into the side buffer channels and fills the funnel-type junctions between the channels with liquid Nafion resin (FIG. 18a). The junction is typically 10-50 um wide in the opening and 20-50 um long. When filling the channels, the Nafion resin fills the junction and does not flow into the sample channel due to the surface tension. Then, the Nafion resin is removed by applying a negative pressure on the other end of the buffer channel to clear the channel (FIG. 18b). After removing the excess Nafion resin out of the buffer channels and once the main components of the Nafion resin such as water and alcohol have been evaporated completely, the Nafion resin trapped in the junction forms an ion-selective membrane between the channels (FIG. 18c). The whole device is heated up to 95° C. on a hotplate and is ready to use after 30 min (FIG. 18d). To increase the bonding strength between the Nafion membrane and the device, the surface of the device can be treated with the Prime Coat first and then the channels can be filled with Nafion resin, as described herein above.

In one embodiment, such fabrication method is advantageous. The main advantages of this fabrication method are as follows: I) a high-aspect-ratio ion-selective membrane can be made which is as high as the microchannel. This high-aspect-ratio membrane can increase the concentration ratio and allows a pressure-driven flow to concentrate various proteomic samples; II) a reversible, non-permanent bonding is possible without using the oxygen plasma of the PDMS chip to the glass substrate. Since the cover can be reversibly bonded without any plasma treatment, surface chemistry can be performed for an immunoassay on the glass substrate first (prior to bonding), second, molecules can be concentrated after reversibly bonding the PDMS device on top of the surface functionalized glass substrate, and then the PDMS device can simply be peeled off the glass substrate to perform any following operations. This procedure can simplify the entire immunoassay; III) this fabrication method can be applied to various common microfluidic chip materials such as PMMA (polymethylmethacrylate) or COC (cyclic olefin copolymer). Accordingly, preconcentration chips with more durable plastic materials than PDMS can be made; IV) In addition to Nafion, any ion-selective resins available in a liquid form as well as colloidal particles in suspension with surface charge or a combination thereof can be applied in this fabrication method.

In some embodiments, the methods for producing planar micro- or nano-fluidic devices with ion-selective membranes of this invention, may comprise, the preparation of a high-aspect-ratio ion selective membrane, as exemplified in some embodiments herein. In some embodiments, such method may comprise building a high-aspect ratio membrane with a microbead-based approach, as will be appreciated by one skilled in the art. Self-assembled colloidal particles may be infiltrated with a resin, for example, Nafion, as described herein. In another embodiment, a trench, which is filled with the resin may be used to build the high-aspect ratio membrane, or in another embodiment, a laminar flow patterning technique, for example utilizing polyelectrolytes as described herein may be utilized. The latter may be accomplished, for example by constructing the membrane with PEO/PAA electrolytes, which undergo hydrogen bonding, or in another embodiment, PSS/PAH may be utilized, which undergo electrostatic interaction, the assemblies may then be infiltrated with a resin, for example Nafion. By patterning micro/nanochannels either in the glass substrate or in the PDMS chip and by filling them with Nafion, one can also create a high-aspect-ratio membrane.

In some embodiments, this invention provides a method for the preparation of a concentrating device comprising:
a fluidic chip comprising a planar array of channels through which a liquid comprising a species of interest can be made to pass;
at least one rigid substrate connected thereto such that at least a portion of a surface of said substrate bounds said channels; and
a high aspect ratio ion-selective membrane which bounds a portion of a surface of one of said channels;
   said method comprising:
applying a liquid polymer to at least a portion of one of said channels whereby said polymer is applied for a time sufficient to form a layer of said polymer on a portion of a surface of one of said channels; and
providing conditions such that said liquid polymer layer forms a membranous structure;

In some embodiments, the liquid polymer comprises microbeads, which are infiltrated with the liquid polymer. In some embodiments, the liquid polymer is liquid Nafion.

It is to be understood that any method used to construct a high-aspect ratio ion-selective membrane, based upon the methodology described herein and any modification thereof is to be considered as part of this invention.

The invention provides concentrating or pre-concentrating devices. In some embodiments, the concentrating device, which is referred to as a “concentrator”, in another embodiment, comprises at least one microchannel and/or at least one nanochannel, placed on a substrate in a roughly planar format, wherein the channel comprises an ion-selective membrane, and the channel is bounded by a rigid substrate.

In one embodiment, the fluidic chip comprising a planar array of channels through which a liquid comprising a species of interest can be made to pass is formed using the technology of microfabrication and nanofabrication, for formation of the respective channels.

Microfabrication technology, or microtechnology or MEMS, in one embodiment, applies the tools and processes of semiconductor fabrication to the formation of, for example, physical structures. Microfabrication technology allows one, in one embodiment, to precisely design features (e.g., wells, channels) with dimensions in the range of <1 mm to several centimeters on chips made, in other embodiments, of silicon, glass, or plastics. Such technology may be used to construct the microchannels of the concentrator, in one embodiment.

In another embodiment, construction of the microchannels of the concentrator may be accomplished according to, or based upon any method known in the art, for example, as described in Z. N. Yu, P. Deshpande, W. Wu, J. Wang and S. Y. Chou, Appl. Phys. Lett. 77 (7), 927 (2000); S. Y. Chou, P. R. Krauss, and P. J. Renstrom, Appl. Phys. Lett. 67 (21), 3114 (1995); Stephen Y. Chou, Peter R. Krauss and Preston J. Renstrom, Science 272, 85 (1996) and U.S. Pat. No. 5,772,905 hereby incorporated herein, in their entirety, by reference. In one embodiment, the microchannels can be formed by imprint lithography, interference lithography, self-assembled copolymer pattern transfer, spin coating, electron beam lithography, focused ion beam milling, photolithography, reactive ion-etching, wet-etching, plasma-enhanced chemical vapor deposition, electron beam evaporation, sputter deposition, and combinations thereof. In some embodiments, the methods for preparation of the devices of this invention may comprise or be modifications of Astorga-Wells J. et al, Analytical Chemistry 75: 5207-5212 (2003); or Joensson, M. et al, Proceedings of the MicroTAS 2006 Symposium, Tokyo Japan, Vol. 1, pp. 606-608. Alternatively, other conventional methods can be used to form the microchannels.

In one embodiment, the microchannels are formed as described in J. Han, H. G. Craighead, J. Vac. Sci. Technol., A 17, 2142-2147 (1999) and J. Han, H. G. Craighead, Science 288, 1026-1029 (2000), hereby incorporated fully herein by reference.

In one embodiment, a series of reactive ion etchings are conducted, after which nano- or micro-channels are patterned with standard lithography tools. In one embodiment, the etchings are conducted with a particular geometry, which, in another embodiment, determines the interface between the microchannels, and/or nanochannels. In one embodiment, etchings, which create the microchannels, are performed parallel to the plane in which etchings for the nanochannels are created. In another embodiment, additional etching, such as, for example, and in one embodiment, KOH etching is used, to produce additional structures in the concentrator, such as, for example, for creating loading holes.

In another embodiment, electrical insulation of the concentrator is accomplished. In one embodiment, such insulation is accomplished via nitride stripping and thermal oxidation of the concentrator. In another embodiment, a surface of the concentrator, which in another embodiment is the bottom surface, may be affixed to a substrate, such as, for example, and in one embodiment, a Pyrex wafer. In one embodiment, the wafer may be affixed using anodic bonding techniques.

In one embodiment, construction of the fluidic chip comprising a planar array of channels may be accomplished by methods known to one skilled in the art, or adaptation of such methods, such as, for example those described in U.S. Pat. No. 6,753,200, fully incorporated herein by reference.

In one embodiment, the fabrication may use a shaped sacrificial layer, which is sandwiched between permanent floor and ceiling layers, with the shape of the sacrificial layer defining a working gap. When the sacrificial layer is removed, the working gap becomes a fluid channel having the desired configuration. This approach, in one embodiment, allows a precise definition of the height, width and shape of interior working spaces, or fluid channels, in the structure of a fluidic device.

The sacrificial layer is formed on a substrate, is shaped by a suitable lithographic process, for example, and is covered by a ceiling layer. Thereafter, the sacrificial layer may be removed with a wet chemical etch, leaving behind empty spaces between the floor and ceiling layers which form working gaps which may be used as flow channels and chambers for the concentrator. In such a device, the vertical dimension, or height, of a working gap is determined by the thickness of the sacrificial layer film, which is made with precise chemical vapor deposition (CVD) techniques, and accordingly, this dimension can be very small.

In order to provide access to the sacrificial layer contained in the structure for the etching solution, which is used to remove the sacrificial layer, one or more access holes may be cut through the ceiling layer, with the wet etch removing the sacrificial layer through these holes. An extremely high etch selectivity may be required between the sacrificial layer and the dielectric layers in order to allow the etch to proceed in the sacrificial layer a significant distance laterally from the access holes without consuming the floor and ceiling layers which compose the finished device. One combination of materials, which may be used for such a process is polysilicon and silicon nitride, for the sacrificial layer and for the floor and ceiling layers, respectively. Extremely high etch selectivities can be obtained with basic solutions such as, in some embodiments, potassium hydroxide (KOH), sodium hydroxide (NaOH), or in another embodiment, tetramethyl ammonium hydroxide (TMAH).

In some embodiments, the ceiling layer is the rigid substrate with which the ion-selective membrane is associated.

The access holes cut in the top layer may be covered, in another embodiment. For this purpose, a sealing layer of silicon dioxide may be deposited on top of the ceiling lay to fill in the access holes, and this additional thin film layer provides a good seal against leakage or evaporation of fluids in the working gap. SiO2 CVD techniques, represent other embodiments, which yield a low degree of film conformality, such as very low temperature oxide (VLTO) deposition, form a reliable seal without excessive loss of device area due to clogging near the access holes. If desired, the access holes may be drilled through the bottom layer, instead of or in addition to the holes in the ceiling layer, and later resealed by depositing a layer of silicon dioxide.

For example, in some embodiments, chemical vapor deposition (CVD) may be used to deposit the device materials, including permanent wall materials, which are usually a dielectric material such as silicon nitride or silicon dioxide, and nonpermanent sacrificial layer materials, such as amorphous silicon or polysilicon.

In some embodiments, micro-channels and/or nano-channels are oriented in parallel on the chip, forming an array of channels, wherein each channel may represent a concentrator, such that multiple parallel concentrations may be accomplished on a single chip. In some embodiments, the channels intersect, such that material concentrated in a channel can, under appropriate conditions be conveyed to another concentrator on the chip, for example, post assay or exposure to a particular reagent. According to this aspect, and in some embodiments, the array or channels, which intersect, allow for multi-step concentration, for example following manipulation or exposure to a dilute environment, and repeat concentration is desirable.

In some embodiments, the microchannels are positioned in any desired orientation, for example as befitting to suit a particular purpose or collection scheme, etc. axis of another.

In one embodiment, an interface region is constructed which connects the channels on the chip, for example two microchannels of the concentrator of this invention. In one embodiment, diffraction gradient lithography (DGL) is used to form a gradient interface between the channels of this invention, where desired. In one embodiment, the gradient interface region may regulate flow through the concentrator, or in another embodiment, regulate the space charge layer formed in the microchannel, which, in another embodiment, may be reflected in the strength of electric field, or in another embodiment, the voltage needed to generate the space charge layer in the microchannel. In some embodiments, the ion-selective membrane is positioned at such an interface.

In one embodiment, the gradient interface area is formed of lateral spatial gradient structures for narrowing the cross section of a value on a desired scale, for example, from the micron to the nanometer length scale. In another embodiment, the gradient interface area is formed of a vertical sloped gradient structure. In another embodiment, the gradient structure can provide both a lateral and vertical gradient.

In one embodiment, the concentrating device may be fabricated by diffraction gradient lithography, by forming a microchannel or microchannels on a substrate and forming a gradient interface area between the desired channels. The gradient interface area can be formed, in one embodiment, by using a blocking mask positioned above a photo mask and/or photoresist during photolithography. The edge of the blocking mask provides diffraction to cast a gradient light intensity on the photoresist.

In one embodiment, a concentrator may comprise a plurality of channels, including a plurality of microchannels, and/or a plurality of nanochannels, or a combination thereof. In one embodiment, the phrase “a plurality of channels refers to more than two channels, or, in another embodiment, more than 5, or, in other embodiments, more than 10, 96, 100, 384, 1,000, 1,536, 10,000, 100,000 or 1,000,000 channels, or in any number desired to suit a particular purpose. Similarly, arrangement of the channels on the chip may be so designed as to suit a particular application.

In one embodiment, the width of the microchannel is between 1-100 μm, or in another embodiment, between 1 and 15 μm, or in another embodiment, between 20 and 50 μm, or in another embodiment, between 25 and 75 μm, or in another embodiment, between 50 and 100 μm. In one embodiment, the depth of the microchannel is between 0.5-50 μmμm, or in another embodiment, between 0.5 and 5 μm, or in another embodiment, between 5 and 15 μm, or in another embodiment, between 10 and 25 μm, or in another embodiment, between 15 and 50 μm, or in another embodiment, between 1 μm-50 μm, or in another embodiment, between 10 and 25 μm, or in another embodiment, between 15 and 40 μm, or in another embodiment, between 25 and 50 μm. In another embodiment, the depth of the channel is between 1 μm-50 μm, or in another embodiment, between 5 and 25 μm, or in another embodiment, between 15 and 40 μm, or in another embodiment, between 25 and 50 μm.

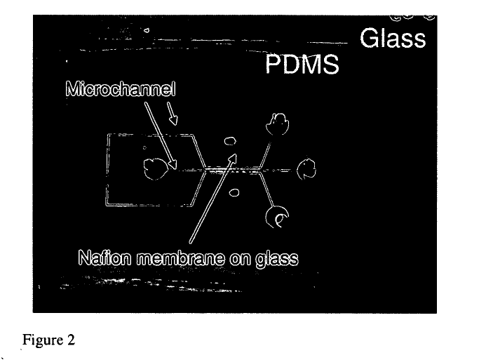

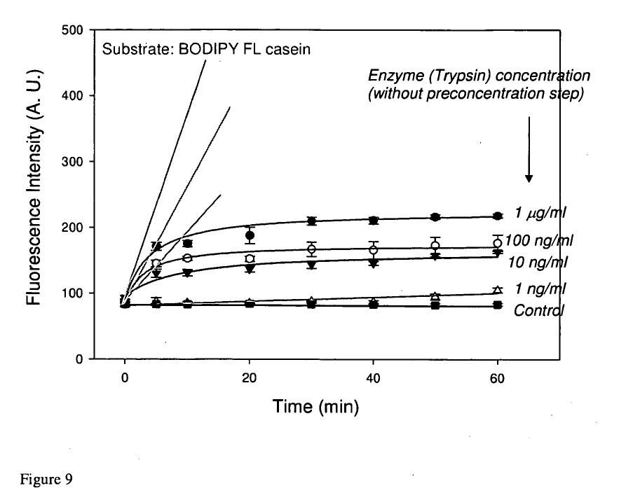

In one embodiment, the concentrator is constructed as diagrammed in FIG. 2, or according to the schematic provided in FIG. 9. The microchannels (9-10), are oriented in a circular array, with the channels bounded by the chips floor and ceiling. The ceiling comprises loading ports (9-20, 9-30) for sample and buffer introduction, respectively.

In another aspect of the invention, the concentrator further comprises at least one sample reservoir in fluid communication with the microchannel or microchannels. In another embodiment, the sample reservoir is capable of releasing a fluid or liquid comprising a species of interest. In one embodiment, the sample reservoir is connected to the microchannel by means of a conduit, which may have the dimensions of the microchannel, or may comprise a gradient interface area, as described.

In one embodiment, the introduction of a liquid comprising a species of interest in the device and independent induction of an electric field in the nanochannel and/or in the microchannel, concentrates the species of interest within the channel.

In one embodiment, the concentrator makes use of an ion-selective membrane to generate ion-depletion regions for electrokinetic trapping, as exemplified and described herein.

In one embodiment, an electric field is applied to the concentrator and generates an ion-depletion region and extended space charge layer that traps anionic molecules. A tangential field in the anodic side may generate electroosmotic flow, which draws molecules into a trapped region.

In one embodiment, flow in the device may be pressure-driven, and may be accomplished by any means well known to one skilled in the art. In another embodiment, the flow may be a hybrid of pressure-driven and electrokinetic flow.

In one embodiment, the phrases “pressure-driven flow” refers to flow that is driven by a pressure source external to the channel segment through which such flow is driven, as contrasted to flow that is generated through the channel segment in question by the application of an electric field through that channel segment, which is referred to herein, in one embodiment, as “electrokinetically driven flow.”

Examples of pressure sources include negative and positive pressure sources or pumps external to the channel segment in question, including electrokinetic pressure pumps, e.g., pumps that generate pressure by electrokinetically driven flow in a pumping channel that is separate from the channel segment in question, provided such pumps are external to the channel segment in question (see, U.S. Pat. Nos. 6,012,902 and 6,171,067, each of which is incorporated herein by reference in its entirety for all purposes).

In one embodiment, the term “electrokinetic flow” refers to the movement of fluid or fluid borne material under an applied electric field. Electrokinetic flow generally encompasses one or both of electrophoresis, e.g., the movement of charged species through the medium or fluid in which it is disposed, as well as electroosmosis, e.g., the electrically driven movement of the bulk fluid, including all of its components. Accordingly, when referred to in terms of electrokinetic flow, it will be appreciated that what is envisioned is the full spectrum of electrokinetic flow from predominantly or substantially completely electrophoretic movement of species, to predominantly electroosmotically driven movement of material, e.g., in the case of uncharged material, and all of the ranges and ratios of the two types of electrokinetic movement that fall between these extremes.

In one embodiment, reference to the term “liquid flow” may encompass any or all of the characteristics of flow of fluid or other material through a passage, conduit, channel or across a surface. Such characteristics include without limitation the flow rate, flow volume, the conformation and accompanying dispersion profile of the flowing fluid or other material, as well as other more generalized characteristics of flow, e.g., laminar flow, creeping flow, turbulent flow, etc.

In one embodiment, hybrid flow may comprise pressure-based relay of the liquid sample into the channel network, followed by electrokinetic movement of materials, or in another embodiment, electrokinetic movement of the liquid followed by pressure-driven flow.

In one embodiment, the electric field may be induced in the respective channels by applying voltage from a voltage supply to the device. In one embodiment voltage is applied by way of the placement of at least one pair of electrodes capable of applying an electric field across at least some of the channels in at least one direction. Electrode metal contacts can be integrated using standard integrated circuit fabrication technology to be in contact with at least one microchannel, or in another embodiment, at least one nanochannel, or in another embodiment, a combination thereof, and oriented as such, to establish a directional electric field. Alternating current (AC), direct current (DC), or both types of fields can be applied. The electrodes can be made of almost any metal, and in one embodiment, comprise thin Al/Au metal layers deposited on defined line paths. In one embodiment, at least one end of one electrode is in contact with buffer solution in the reservoir.

In another embodiment, the concentrator may contain at least two pairs of electrodes, each providing an electric field in different directions. In one embodiment, field contacts can be used to independently modulate the direction and amplitudes of the electric fields to, in one embodiment, orient the space charge layer, or in another embodiment, move macromolecules at desired speed or direction, or in another embodiment, a combination thereof.

In one embodiment, the voltage applied is between 50 mV and 1500 V. In one embodiment, the voltage supply applies equal voltage to opposing sides of the microchannel, or in another embodiment, the voltage supply applies greater voltage to the anodic side of said microchannel, as compared to the cathodic side.

In one embodiment, the voltage supply may be any electrical source, which may be used to provide the desired voltage. The electrical source may be any source of electricity capable of generating the desired voltage. For example, the electrical source may be a pizoelectrical source, a battery, or a device powered by household current. In one embodiment, a pizoelectrical discharge from a gas igniter may be used.

In one embodiment, the electrokinetic trapping in the device and sample collection can occur over a course of minutes, or in another embodiment, can be maintained for several hours. In one embodiment, concentration over a course of time results in concentration factors as high as 10⁶-10⁸, and in another embodiment, may be even higher, upon optimization of the conditions employed during the concentration, such as by modifying the voltage applied, salt concentration of the liquid, pH of the liquid, ion-selective membrane choice of materials or thickness or combination thereof.

In another embodiment, the concentrator further comprises at least one waste reservoir in fluid communication with the microchannel, microchannels, nanochannel and/or nanochannels of the concentrator. In one embodiment, the waste reservoir is capable of receiving a fluid.

In one embodiment, the surface of the microchannel may be functionalized to reduce or enhance adsorption of the species of interest to the surface of the concentrator. In another embodiment, the surface of the nanochannel and/or microchannel has been functionalized to enhance or reduce the operation efficiency of the device. In another embodiment, external gate potential is applied to the substrate of the device, to enhance or reduce the operation efficiency of the device. In another embodiment, the device is comprised of a transparent material. In another embodiment, the transparent material is pyrex, silicon dioxide, silicon nitride, quartz, PMMA, PC or acryl.

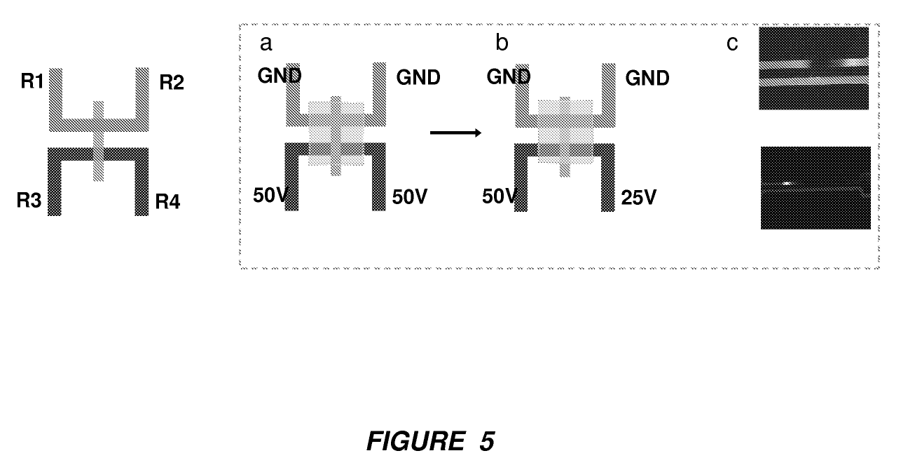

In another embodiment, the concentrator is adapted such that analysis of a species of interest may be conducted, in one embodiment, in the concentrator, or in another embodiment, downstream of the concentrator. In one embodiment, analysis downstream of the concentrator refers to removal of the concentrated species from the device, and placement in an appropriate setting for analysis, or in another embodiment, construction of a conduit from the concentrator which relays the concentrated material to an appropriate setting for analysis. In one embodiment, such analysis may comprise signal acquisition, and in another embodiment, a data processor. In one embodiment, the signal can be a photon, electrical current/impedance measurement or change in measurements. It is to be understood that the concentrating device of this invention may be useful in various analytical systems, including bioanalysis Microsystems, due to its simplicity, performance, robustness, and integrabilty to other separation and detection systems, for example as described hereinbelow and depicted in FIG. 5. It is to be understood that any integration of the device into such a system is to be considered as part of this invention.

In another embodiment, the concentrator, or in another embodiment, the microchannel or microchannels are capable of being imaged with a two-dimensional detector. Imaging of the concentrator, or parts thereof, may be accomplished by presenting it to a suitable apparatus for the collection of emitted signals, such as, in some embodiments, optical elements for the collection of light from the microchannels.

In another embodiment, the device is coupled to a separation system, or in another embodiment, a detection system, or in another embodiment, an analysis system or in another embodiment, a combination thereof. In another embodiment, the device is coupled to an illumination source. According to this aspect, and in some embodiments, assay of concentrated materials may be accomplished within devices as herein described, and their analysis may be affected by coupling appropriate detection apparatus and systems to the device to conduct such analysis. In some embodiments, such assay may be enzymatic assay, probe detection of a desired product, synthetic procedures, digestion of materials, or others as will be appreciated by one skilled in the art.

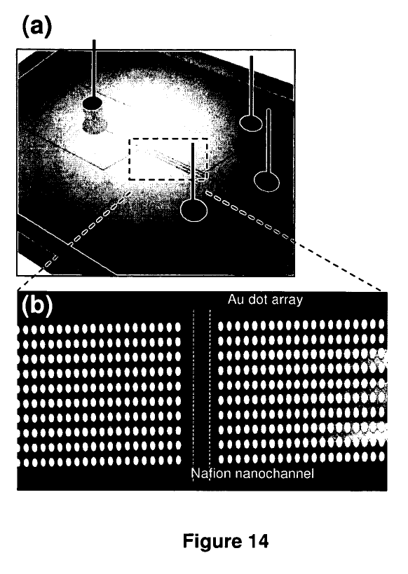

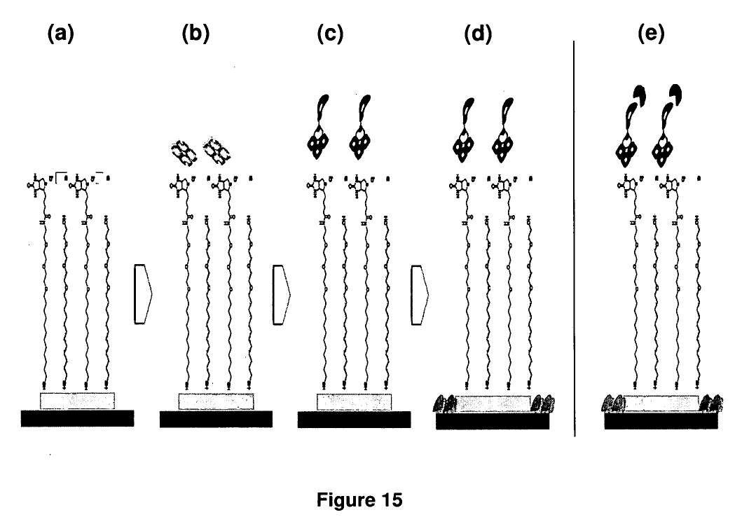

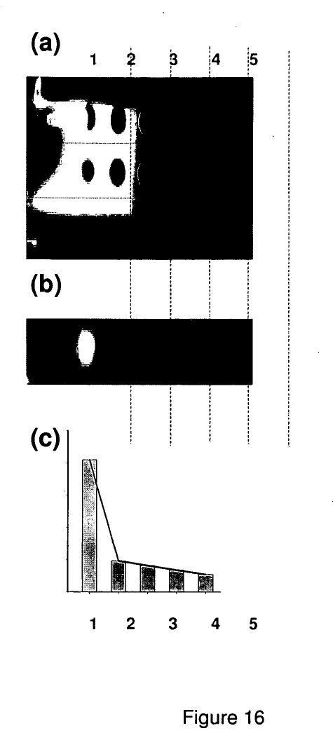

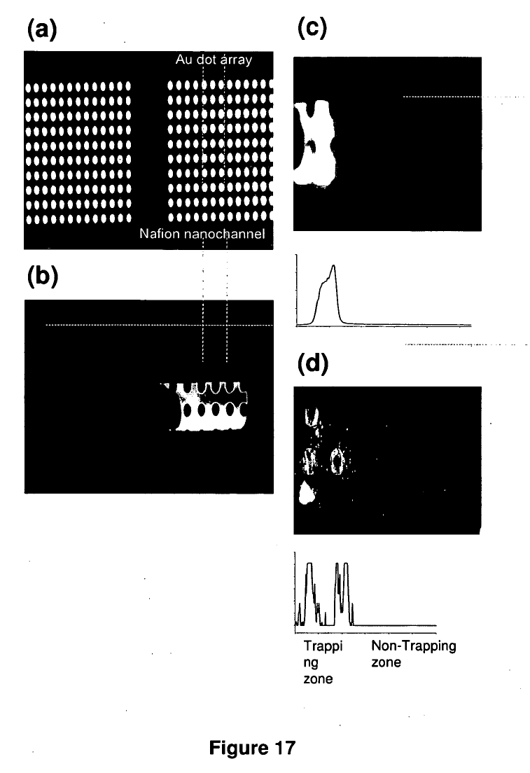

In one embodiment, coupling of a prenconcentrator with surface-patterned Nafion membrane and immunoassay in PBS 1× medium is conducted as follows: The microfluidic preconcentrator is coupled to a surface immunoassay (See FIG. 14) and an increased binding rate of the immuassay is demonstrated using the preconcentrator. In this integrated preconcentration-immuno assay device, The Prime Coat is patterned first on a glass substrate followed by the Nafion resin, as described herein above. In one embodiment, the glass substrate contains an array of previously e-beam deposited Au dots. The surface of the Au-dots is then functionalized with an antibody such as anti-hcG. For the surface functionalization, standard thiol chemistry is used (FIG. 15). To test the binding between the streptavidin and biotinylated surface, the streptavidin molecules are concentrated on the biotinylated Au surface in PBS 1× and its increased binding onto the Au surface is observed (FIG. 16). Finally, the hcG protein is concentrated above the surface-functionalized Au-dots in PBS 1× buffer and an increased binding rate of the hcG to anti-hcG is demonstrated (see FIG. 17).

In one embodiment, the concentrator may be disposable, and in another embodiment, may be individually packaged, and in another embodiment, have a sample loading capacity of 1-50,000 individual fluid samples. In one embodiment, the concentrator can be encased in a suitable housing, such as plastic, to provide a convenient and commercially-ready cartridge or cassette. In one embodiment, the concentrator will have suitable features on or in the housing for inserting, guiding, and aligning the device, such that, for example, a sample loading compartment is aligned with a reservoir in another device, which is to be coupled to the concentrator. For example, the concentrator may be equipped with insertion slots, tracks, or a combination thereof, or other adaptations for automation of the concentration process via a device of this invention.

The concentrator may be so adapted, in one embodiment, for high throughput screening of multiple samples, such as will be useful in proteomics applications, as will be appreciated by one skilled in the art.

In one embodiment, the concentrator is connected to electrodes, which are connected to an electric potential generator, which may, in another embodiment be connected with metal contacts. Suitable metal contacts can be external contact patches that can be connected to an external scanning/imaging/electric-field tuner, in another embodiment.

In one embodiment of the present invention, the concentrator is a part of a larger system, which includes an apparatus to excite molecules inside the channels and detect and collect the resulting signals. In one embodiment, a laser beam may be focused upon the sample plug, using a focusing lens, in another embodiment. The generated light signal from the molecules inside the microchannels may be collected by focusing/collection lens, and, in another embodiment, reflected off a dichroic mirror/band pass filter into optical path, which may, in another embodiment, be fed into a CCD (charge coupled device) camera.

In another embodiment, an exciting light source could be passed through a dichroic mirror/band pass filter box and focusing/collecting scheme from the top of the concentrator. Various optical components and devices can also be used in the system to detect optical signals, such as digital cameras, PMTs (photomultiplier tubes), and APDs (Avalanche photodiodes).

In another embodiment, the system may further include a data processor. In one embodiment, the data processor can be used to process the signals from a CCD, to a digital image of the concentrated species onto a display. In one embodiment, the data processor can also analyze the digital image to provide characterization information, such as size statistics, histograms, karyotypes, mapping, diagnostics information and display the information in suitable form for data readout.

In one embodiment, the device is further modified to contain an active agent in the microchannel. For example, and in one embodiment, the microchannel is coated with an enzyme at a region wherein the concentrated molecules will be trapped, according to the methods of this invention. According to this aspect, the enzyme, such as, a protease, may come into contact with concentrated proteins, and digest them. According to this aspect, the invention provides a method for proteome analysis, wherein, for example, a sample comprising a plurality of cellular polypeptides is concentrated in the microchannel, to obtain a plurality of substantially purified polypeptides. The polypeptide is exposed to a protease immobilized within the microchannel, under conditions sufficient to substantially digest the polypeptide, thereby producing digestion products or peptides. The digestion products may, in another embodiment, then be transported to a downstream separation module where they are separated, and in another embodiment, from there, the separated digestion products may be conveyed to a peptide analysis module. The amino acid sequences of the digestion products may be determined and assembled to generate a sequence of the polypeptide. Prior to delivery to a peptide analysis module, the peptide may be conveyed to an interfacing module, which in turn, may perform one or more additional steps of separating, concentrating, and or focusing.

In other embodiments, the proteases include, but are not limited to: peptidases, such as aminopeptidases, carboxypeptidases, and endopeptidases (e.g., trypsin, chymotrypsin, thermolysin, endoproteinase Lys C, endoproteinase GluC, endoproteinase ArgC, endoproteinase AspN). Aminopeptidases and carboxypeptidases are useful in characterizing post-translational modifications and processing events. Combinations of proteases also can be used. In one embodiment, the proteases and/or other enzymes can be immobilized onto the microchannel surface using adsorptive or covalent methods. In some embodiments, examples of covalent immobilization include direct covalent attachment of the protease to a surface with ligands such as glutaraldehyde, isothiocyanate, and cyanogen bromide. In other embodiments, the proteases may be attached using binding partners which specifically react with the proteases or which bind to or react with molecules which are themselves coupled to the proteases (e.g., covalently). Binding pairs may include the following: cytostatin/papain, valphosphanate/carboxypeptidase A, biotin/streptavidin, riboflavin/riboflavin binding protein, antigen/antibody binding pairs, or combinations thereof.

In one embodiment, the steps of concentrating polypeptides obtained from a given cell, producing digestion products, and analyzing digestion products to determine protein sequence, can be performed in parallel and/or iteratively for a given sample, providing a proteome map of the cell from which the polypeptides were obtained. Proteome maps from multiple different cells can be compared to identify differentially expressed polypeptides in these cells, and in other embodiments, the cells may be subjected to various treatments, conditions, or extracted from various sources, with the proteome map thus generated reflecting differential protein expression as a result of the status of the cell. It is to be understood that such concentration and assay comprise methods of this invention.

In some embodiments, the devices/methods of this invention may be used to concentrate a desired material from a biological sample. In some embodiments, the biological sample may be a fluid. In one embodiment, such a fluid may comprise bodily fluids such as, in some embodiments, blood, urine, serum, lymph, saliva, anal and vaginal secretions, perspiration and semen, or in another embodiment, homogenates of solid tissues, as described, such as, for example, liver, spleen, bone marrow, lung, muscle, nervous system tissue, etc., and may be obtained from virtually any organism, including, for example mammals, rodents, bacteria, etc. In some embodiments, the solutions or buffered media may comprise environmental samples such as, for example, materials obtained from air, agricultural, water or soil sources, which are present in a fluid which can be subjected to the methods of this invention.

In another embodiment, such samples may be biological warfare agent samples; research samples and may comprise, for example, glycoproteins, biotoxins, purified proteins, etc. In another embodiment, such fluids may be diluted.

In one embodiment, this invention provides an array architecture that is capable of being scaled to at least 10,000 concentrators, suitable for a real-world screen.

In one embodiment, concentration efficiency may be determined by using labeled proteins or polypeptides, introduced into the concentrator in known ratios and detecting the concentrated labeled protein or polypeptides, such as exemplified hereinbelow. Signal intensity can be determined as a function of time, over background noise.

In one embodiment, the concentrators of this invention may be under controlled physicochemical parameters, which may comprise temperature, pH, salt concentration, or a combination thereof.

In one embodiment, the invention provides for a method of concentrating a species of interest in a liquid, comprising using a device of the invention, or one prepared by a process as herein described.

In one embodiment, the invention provides for a method of concentrating a species of interest in a liquid, the method comprising applying a liquid comprising the species of interest to the device of this invention.

In one embodiment, the method further comprises the steps of:
inducing an electric field in the channel whereby ion depletion occurs in a region in the channel proximal to the ion-selective membrane, and a space charge layer is formed within the channel, which provides an energy barrier to said species of interest; and
inducing liquid flow in the channel.

In one embodiment, the flow is electroosmotic, or in another embodiment, the flow is pressure driven.

In one embodiment, the steps are carried out cyclically.

In one embodiment, inducing an electric field in said channel is by applying voltage to said device, which in one embodiment is between 50 mV and 1500 V. In one embodiment, equal voltage is applied to the two sides of the channel, or in another embodiment, greater voltage is applied to the anodic side of the channel, as compared to the cathodic side.

In one embodiment, a space charge layer is generated in the channel prior to applying greater voltage to the anodic side of said channel.

According to this aspect of the invention and in another embodiment, the device is coupled to a separation system, detection system, analysis system or combination thereof.

In one embodiment, the liquid is a solution. In another embodiment, the liquid is a suspension, which, in another embodiment is an organ homogenate, cell extract or blood sample. In one embodiment, the species of interest comprises proteins, polypeptides, nucleic acids, viral particles, or combinations thereof. In one embodiment, the species of interest is a protein, nucleic acid, virus or viral particle found in, or secreted from a cell, and in another embodiment, is found in very low quantities, such that it represents less than 10% of the protein extracted form a protein extract of the cell.

In one embodiment, the methods of this invention and the devices of this invention enable collection of molecules from a relatively large (˜1 μL or larger) sample volume, and their concentration into a small (1 pL˜1 nL) volume. Such concentrated sample can then, in other embodiments, be efficiently sorted, separated or detected by various microfluidic systems, without sacrificing the overall detection sensitivity caused by the small sample volume capacity of microfluidic biomolecule sorting/detection systems.

In one embodiment, the methods and concentrating devices of this invention allow for significantly increased signal intensity of a molecules, and subsequent just detection, which, in another embodiment, allows for more aggressive molecular sorting and/or removal of high-abundance molecules, such as proteins, from a sample, without sacrificing the detectability of molecules in minute concentration, such as minor proteins or peptides.

In another embodiment, the devices for and methods of concentration of this invention enable the use of several non-labeling detection techniques (UV absorption, for example), which was not possible due to the short path length and small internal volume of conventional microfluidic channels. Therefore, in another embodiment, the devices for and methods of concentration of this invention, which combine concentration and molecular sorting may provide an ideal platform for integrated microsystems for biomarker detection, environmental analysis, and chemical-biological agent detection.

In one embodiment, the method further comprises the step of releasing the species of interest from the device. In one embodiment, the method further comprises the step of subjecting the species of interest to capillary electrophoresis.

Capillary electrophoresis is a technique that utilizes the electrophoretic nature of molecules and/or the electroosmotic flow of samples in small capillary tubes to separate sample components. Typically a fused silica capillary of 100 μm inner diameter or less is filled with a buffer solution containing an electrolyte. Each end of the capillary is placed in a separate fluidic reservoir containing a buffer electrolyte. A potential voltage is placed in one of the buffer reservoirs and a second potential voltage is placed in the other buffer reservoir. Positively and negatively charged species will migrate in opposite directions through the capillary under the influence of the electric field established by the two potential voltages applied to the buffer reservoirs. The electroosmotic flow and the electrophoretic mobility of each component of a fluid will determine the overall migration for each fluidic component. The fluid flow profile resulting from electroosmotic flow is flat due to the reduction in frictional drag along the walls of the separation channel. The observed mobility is the sum of the electroosmotic and electrophoretic mobilities, and the observed velocity is the sum of the electroosmotic and electrophoretic velocities.

In one embodiment of the invention, a capillary electrophoresis system is micromachined onto a device, which is a part of, or separate from, the concentrating device described herein. Methods of micromachining capillary electrophoresis systems onto devices are well known in the art and are described, for example in U.S. Pat. No. 6,274,089; U.S. Pat. No. 6,271,021; Effenhauser et al., 1993, Anal. Chem. 65: 2637-2642; Harrison et al., 1993, Science 261: 895-897; Jacobson et al., 1994, Anal. Chem. 66:1107-1113; and Jacobson et al., 1994, Anal. Chem. 66: 1114-1118.

In one embodiment, the capillary electrophoresis separations provide a sample which may then be used for both MALDI-MS and/or ESI-MS/MS-based protein analyses (see, e.g., Feng et al., 2000, Journal of the American Society For Mass Spectrometry 11: 94-99; Koziel, New Orleans, La. 2000; Khandurina et al., 1999, Analytical Chemistry 71: 1815-1819.

In other embodiments, downstream separation devices, which may interface with the concentrator of this invention include, but are not limited to, micro high performance liquid chromatographic columns, for example, reverse-phase, ion-exchange, and affinity columns.

It is to be understood that the exact configuration of any systems, devices, etc. which are coupled downstream of the concentrating device are to be considered as part of this invention, and that the configuration may be varied, to suit a desired application. In one embodiment, a module for separation of the concentrated peptides which is positioned downstream of the concentrating device comprises a separation medium and a capillary between the ends of which an electric field is applied. The transport of a separation medium in the capillary system and the injection of the sample to be tested (e.g., a sample band comprising peptides and/or partially digested polypeptides) into the separation medium can be carried out with the aid of pumps and valves, or in another embodiment, via electric fields applied to various points of the capillary.

In another embodiment, the method is utilized to detect said species of interest when said species is present in said liquid at a concentration, which is below a limit of detection.

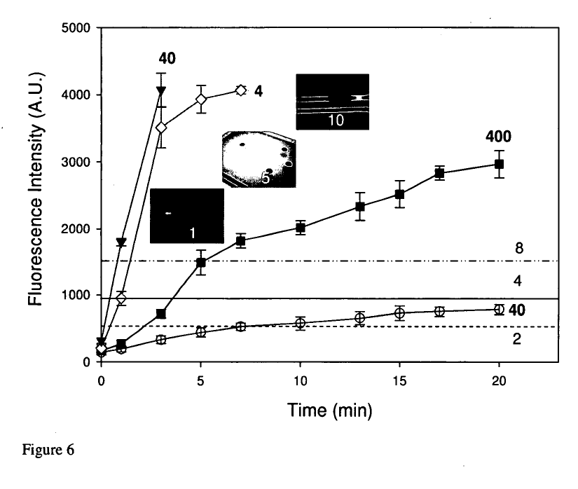

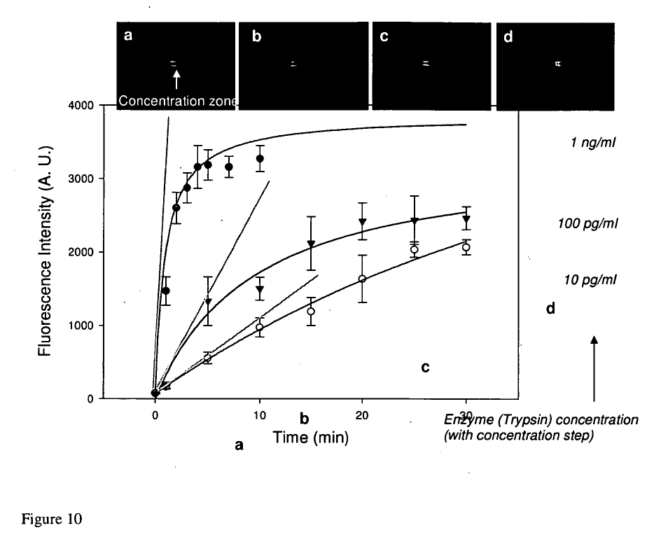

As exemplified hereinbelow (FIGS. 6 and 10), concentration and assay of low abundance proteins is readily accomplished with the devices/methods of this invention. Concentration of a low abundance protein of 10⁴ times was achieved in as little as 4 minutes, and a roughly 1000-fold enhancement in assay sensitivity was achieved, as compared to similar assay without using the concentration methods/devices of this invention.

In other embodiments, various applications of the methods of the present invention are possible without deviating from the present invention.

By way of example, the concentrating and pumping methods of the present invention allow for high-throughput robotic assaying systems to directly interface with the devices of the present invention, and to concentrate a species of interest, and/or and pump liquid.

Various modes of carrying out the invention are contemplated as being within the scope of the following claims particularly pointing out and distinctly claiming the subject matter, which is regarded as the invention.

### EXAMPLES

### Materials and Methods

### Device Fabrication:

Fabrication techniques for a microfluidic device comprising micro- or nano-channels were similar to those described (J. Han, H. G. Craighead, J. Vac. Sci. Technol., A 17, 2142-2147 (1999); J. Han, H. G. Craighead, Science 288, 1026-1029 (2000)). A PDMS device comprising microchannels was fabricated.

A Nafion perfluorinated resin solution (5 wt. % in lower aliphatic alcohols and water containing 15-20% water) was used to pattern a thin planar Nafion membrane on a standard glass substrate. The membrane was cured and integrated into the channel by plasma bonding a PDMS channel on top of the substrate.

Deposition and patterning of the proton-exchange resin on a glass substrate may be accomplished as follows:

A microfluidic channel with a desired geometry is used. Depending on the application, the channel geometry (length, depth, width) as well as its shape can be altered (single straight line, multiple lines, curves etc.). In this case, 0.5˜1 uL of Nafion resin was flowed under negative pressure through a microfluidic channel of 100 um width and 20 um thickness. The thickness of the membrane can be varied as a function of the applied negative pressure. After completely flushing the resin through the microchannel, a thin film of the membrane remained on the surface of the glass substrate because its hydrophilic surface retained the resin. The resin was cured on a hotplate at 90° C. for ˜3 min.

Another means of deposition and patterning of the proton-exchange resin is via the use of a micro-nano-stamping technique. A PDMS tool with a micron- or nano-sized positive feature is assembled with the desired geometry and pattern. The stamp transfers liquid resin onto an exposed surface of a substrate. The thickness of the membrane can be altered as a function of the resin viscosity and/or hydrophobicity of the PDMS stamp.

Another means of deposition and patterning of the proton-exchange resin is via the use of ink-jet printing techniques. A proton-exchange resin is dispensed on an exposed surface of a substrate, and an arbitrary membrane pattern and geometry is printed thereon, based on the CAD model. After patterning, the resin is cured at 90° C. for 3 min.

Another means of deposition and patterning of the proton-exchange resin is via the use of UV photolithography or e-beam lithography for directly patterning a proton-exchange resin on glass or silicon or another polymer (ex. PDMS) substrate.

In each of the above methods, care is taken such that the membrane formed has a final thickness of between 100-500 nm.

Once the resin has been deposited and the membrane has formed on the substrate, the substrate as well as the microfluidic device comprising channels are plasma bonded according to standard plasma bonding protocols.

Two polyelectrolyte solutions may also be flowed into a microchannel(s), for example PEO/PAA and LPEI/PAA, to create a high-aspect-ratio membrane, which is as high as the channel.

Large, patterned arrays of such devices can be prepared accordingly.

Surface treatment of the glass substrate prior to Nafion patterning was performed in some cases as follows: First, a Sylgard Prime Coat solution was patterned on a glass substrate. This patterning enhanced the adhesion and bonding of silicones to a variety of substrates and enhanced the penetration of the active ingredients into the bonding surface. After depositing the Prime Coat layer on the substrate, a Nafion resin was patterned using various patterning methods as described previously. In this way, the bonding strength was increased and a concentration of the protein sample could be accomplished even in high ionic strength media such as PBS 1×.

### Biomolecule and Reagent Preparation

Molecules and dyes used included B-phycoerythrin, rGFP (BD bioscience, Palo Alto, Calif.), FITC-BSA (Sigma-Aldrich, St. Louis, Mo.), FITC-Ovalbumin (Molecular Probes, Eugene, Oreg.), FITC-BSA (Sigma-Aldrich, St. Louis, Mo.), FITC dye (Sigma-Aldrich, St. Louis, Mo.), Mito Orange (Molecular Probes, Eugene, Oreg.), and lambda-DNA (500 μg/ml). DNA molecules were labeled with YOYO-1 intercalating dyes (Molecular Probles, Eugene, Oreg.) by following manufacturer's instruction.

### Optical Detection Setup

All the experiments were conducted on an inverted microscope (IX-71) with fluorescence excitation light source attached. A thermoelectrically cooled CCD camera (Cooke Co., Auburn Hill, Mich.) was used for fluorescence imaging. Sequences of images were analyzed by IPLab 3.6 (Scanalytics, Fairfax, Va.). A home-made voltage divider was used to distribute different potentials to reservoirs. The built in 100 W mercury lamp was used as a light source.

Channels were filled with 40 nM, 4 nM and 4 μM B-phycoerythrin solutions, and the fluorescence intensity was determined. The camera shutter was opened only during periodical exposures (˜1 sec) to minimize photobleaching of the collected molecules.

Coupling of Preconcentrator with Surface-Patterned Nafion Membrane and Immunoassay in PBS 1× Medium

The microfluidic preconcentrator was coupled to a surface immunoassay (See FIG. 14) and an increased binding rate of the immuassay was demonstrated using the preconcentrator. In this integrated preconcentration-immunoassay device, the Prime Coat was patterned first on a glass substrate followed by the Nafion resin, as described herein above. In one embodiment, the glass substrate contained an array of previously e-beam deposited Au dots. The surface of the Au-dots was then functionalized with an antibody such as anti-hcG. For the surface functionalization, standard thiol chemistry was used (FIG. 15). To test the binding between the streptavidin and biotinylated surface, the streptavidin molecules were concentrated on the biotinylated Au surface in PBS 1× and its increased binding onto the Au surface was observed (FIG. 16). Finally, the hcG protein was concentrated above the surface-functionalized Au-dots in PBS 1× buffer and an increased binding rate of the hcG to anti-hcG was demonstrated (see FIG. 17).

### Example 1

### Fabrication of Planar Electrokinetic Concentration Devices

Since integration of solid ion-selective membranes into microfluidic devices is cumbersome and produces imperfect results, an alternative fabrication method was sought.

Toward this Nafion perfluorinated resin solution (5 wt. % in lower aliphatic alcohols and water containing 15-20% water) was patterned on a standard glass substrate to form a thin membrane. The resin was then cured and integrated into the channel by plasma bonding to a PDMS chip comprising microchannels.

Patterning of the resin onto the substrate surface can be accomplished by multiple methods.

One patterning method makes use of a chip comprising microfluidic channels with a typical geometry of 100 μm width and 20 μm thickness to flow 0.5˜1 μL of the Nafion resin through the channel under negative pressure. Depending on the application, the channel geometry (length, depth, width) as well as its shape can be altered (single straight line, multiple lines, curves etc.). The thickness of the membrane can be varied with the applied negative pressure. After completely flushing the resin through the microchannel, a thin film of the membrane remains on the surface of the glass substrate because its hydrophilic surface retains the resin. The resin is then cured, for example on a hotplate at 90° C. for roughly 3 minutes.

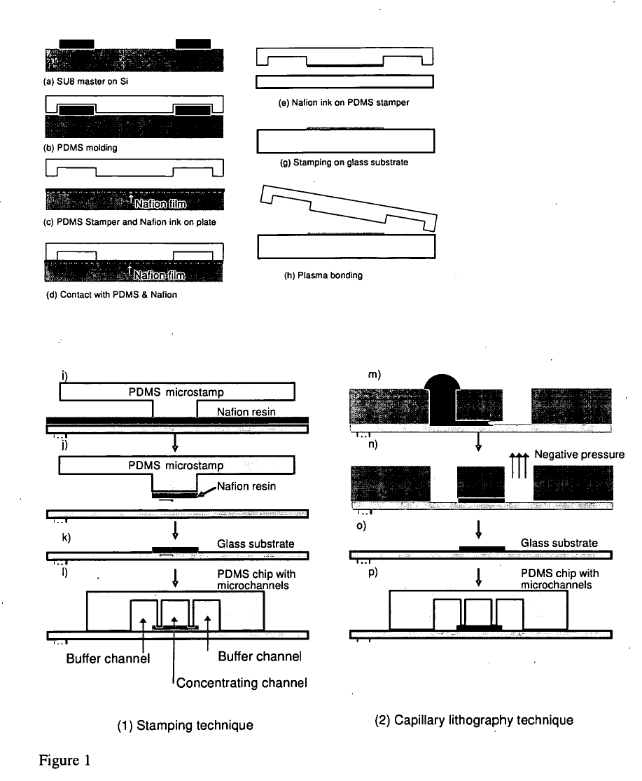

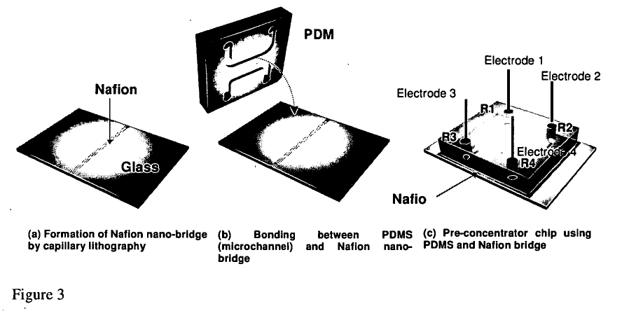

Another patterning method makes use of a micro- or nano-stamping technique. A PDMS tool with a micron- or nano-sized positive feature is prepared, having a desired geometry and pattern. The stamp is used to transfer liquid resin to a surface of the desired substrate, for example a glass substrate. The resulting membrane thickness is a function of the viscosity of the resin as well as the hydrophobicity of the PDMS stamp. The stamping technique is useful in some embodiments for patterning on a large surface of the substrate (FIG. 1). One embodiment of a device constructed by this method is shown in FIG. 2 or 3.

Another patterning method makes use of ink-jet printing. Transfer of a resin with low viscosity to a substrate, such as glass, can be readily accomplished with a drop-on-demand technique such as an ink-jet printing method. Dispensing the resin enables precise depositing of a desired membrane pattern and geometry anywhere on the glass substrate. After patterning, the resin is cured.

Another patterning method makes use of UV photolithography or e-beam lithography for direct patterning of the resin on a glass or silicon or other polymer (ex. PDMS) substrate.

Once the membrane has been prepared on the glass substrate, the final thickness is typically between 100-500 nm.

The methods recited above enable the control of membrane thickness from a range of about several nano meters to several micro meters.

Once cured, the substrate comprising the membrane, and the device comprising microfluidic chambers are plasma bonded together, by standard methodology.

### Example 2

### Electrokinetic Concentration in an Embodiment of a Device of the Invention

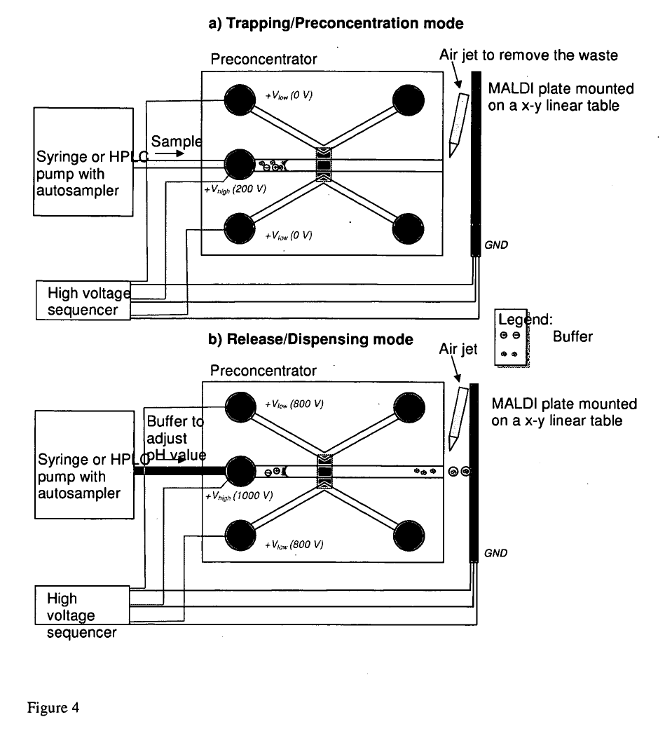

FIG. 4 schematically depicts operation of an embodiment of a device of this invention. According to this aspect, and in one embodiment, operation of the device may entail effecting a trapping mode, where sample (by pressure-driven flow) is injected and then trapped as a function of an applied potential difference of V_{diff}=200 V across the Nafion membrane.

Once preconcentrated, a buffer solution may be injected, for example with an autosampler to adjust the pH value of the sample to the pI value of the trapped molecules. Once the pH value reaches the pI value of the molecules, molecules which are now neutral are released from the electrokinetic trap, which relies on the presence of charge for trapping.

Concentrated samples may then be dispensed. Toward this end, the voltage configuration is changed, which can be accomplished by a high voltage sequencer. According to this aspect, the voltage in the middle channel is increased, e.g., to ˜1 kV to achieve a droplet generation from the channel to the MALDI plate.

In order to retain the buffer ions in the channel (otherwise the dispensed sample would have a high salt concentration), the depletion region has to be further maintained in the dispensing mode. Therefore, the same potential difference, V_{diff}=200V (1000V−800V), is constantly applied across the main and two side channels while dispensing the released molecules from the end of the middle channel. To remove the waste before dispensing the sample, an air jet for example, may be used, near the orifice. Mounting of a MALDI plate on a x-y table may be accomplished, enabling movement of the wells for collection of more samples.

FIG. 5 depicts an embodiment of the pre-concentrator operating scheme. According to this aspect, the device when operated in the “capture” or trapping mode has a voltage applied to opposing sides of the sample channel held at a constant voltage, in this example, at 50V. The buffer channel is grounded.

At this voltage configuration, charged particles are trapped around the Nafion membrane bridge. When the device is operated in release or dispensing mode, the voltage applied to one side of the sample channel is reduced, for example, in this embodiment, to 25V creating a 25V potential difference between opposing sides of the sample channel. This potential difference facilitates particle flow. As can be seen in the insert, the biological marker was readily concentrated in the device.

Effective concentration of compounds of low abundance is shown FIG. 6. β-phycoerythrin preconcentration (in units of fluorescence intensity) was plotted over a course of electrokinetic trapping time. The compound was concentrated by more than 10⁵ in 20 minutes, or by 104 times in 5 minutes.

### Example 3

### Assay of Concentrated Materials

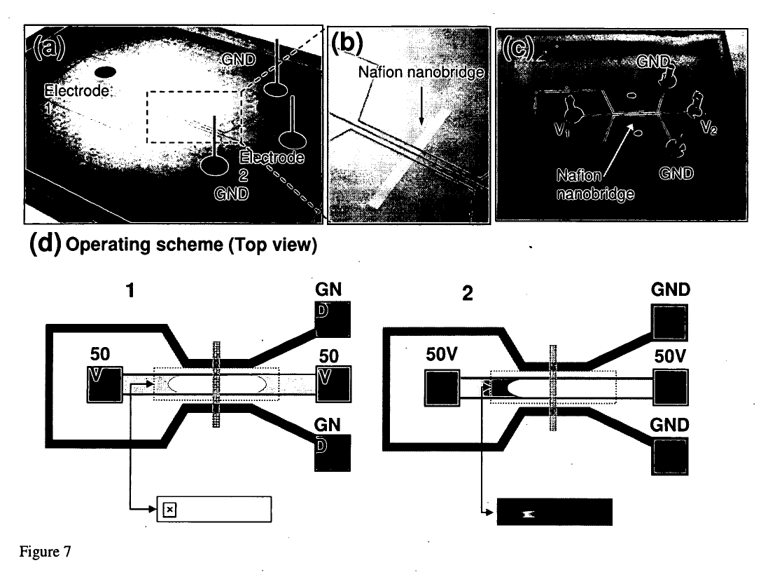

Assay of concentrated materials is one embodied application of the devices and methods of this invention. FIG. 7 schematically depicts assay of material using, for example, low-abundance enzyme, or substrate. In this aspect, the middle channel of an embodied device of this invention is loaded with enzyme/substrate mixtures and the side channels are filled with buffer solutions. To concentrate the premixed solution of enzyme/substrate, a potential difference was applied across the middle and the side channels in combination with an electrokinetic flow. Trapping of the enzyme and substrate facilitates their reaction, and concentration thereof increases the reaction sensitivity, which is useful in assay conditions when the enzyme, substrate, or both are available in limited quantity.

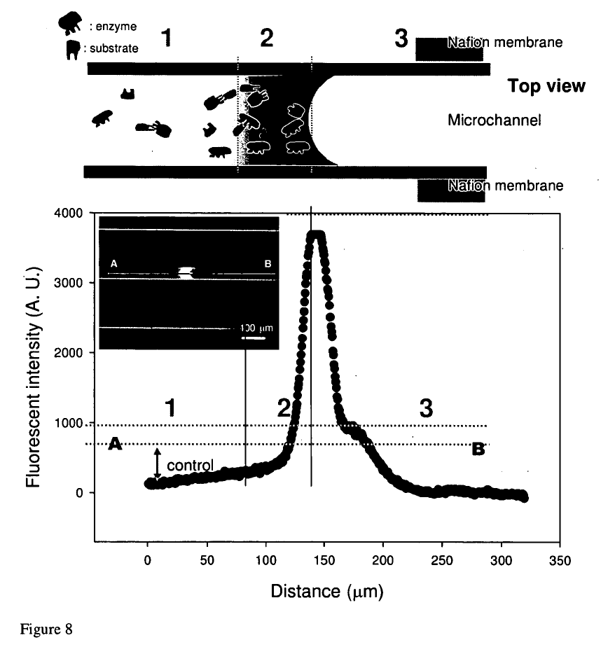

FIG. 8 describes an embodiment of the trapping and assay of a compound in a microchannel, where the assay is an enzymatic assay. Panel A depicts electrokinetic trapping of an enzyme-substrate product in the concentrated zone (zone 2). Zone 1 contains the mixture of trypsin and BODIPY and FL casein in a diffuse arrangement outside of the concentrated zone. In Zone 2, preconcentration allows for enzyme and substrate proximal localization. The increase in fluorescence intensity seen in the graph attests to enzyme-substrate reactivity. Zone 3 illustrates the depletion zone, which enables estimation the background noise generated from the adsorption of enzyme/substrate on the side of the microchannel.

FIG. 9 plots the fluorescence signal intensity of products formed in a device, which was not operated in the concentration mode, in an enzymatic processing assay, where trypsin (enzyme) concentrations ranged from 1 μg/ml to 1 ng/ml. A 50 mg/ml BODIPY FL casein was used as the substrate turnover rate was measured. The reaction curves showed a hyperbolic shape over time, with the limit of detection being ˜10 ng/ml and the reaction time required was roughly 1 hour.

FIG. 10 plots fluorescence signal intensity of product formation of the assay in FIG. 9, when the device is operated in the concentration mode. Enhanced trypsin-catalyzed reaction occurred with preconcentration. Trypsin concentrations ranging from 10 pg/ml to 1 ng/ml (lower concentrations than those used in FIG. 9) for enzyme and 50 ug/ml BODIPY FL casein were used. The limit of detection in this case was roughly 10 pg/ml, a roughly 1000-fold enhancement in assay sensitivity as compared to those obtained in a device not operated in concentration mode. The reaction time required to turn over the substrate with a concentration of 1 ng/ml was roughly 10 minutes, which is 6 times faster than that without preconcentration.

### Example 4

### High-Aspect-Ratio Ion-Selective Membrane-Containing Devices

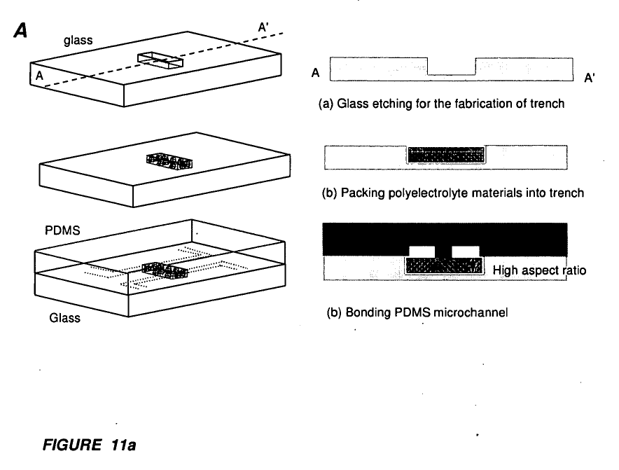

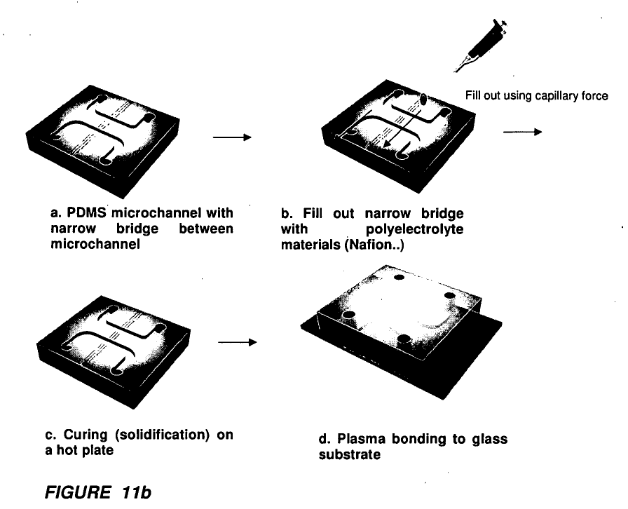

In order to determine whether a higher depletion force could be created, thereby enabling a pressure-driven flow for faster concentration, devices were constructed comprising a high-aspect-ratio ion-selective membrane inside the microchannel, where the membrane height equals that of the channel. In this embodiment of the invention, two polyelectrolytes were flowed into the channel and their electrostatic interaction/hydrogen-bonding interactions resulted in the fabrication of a membrane structure at the liquid junction. Such polyelectrolyte combinations are PEO (poly(ethylene oxide))/PAA (poly(acrylic acid)) and LPEI (linear polyethyleneimine)/PAA, PAA. A high-aspect-ratio membrane was then constructed inside the microchannel of the device shown in FIG. 11.

### Example 5

### Construction of Parallel Disposable Arrays for High Throughput Applications

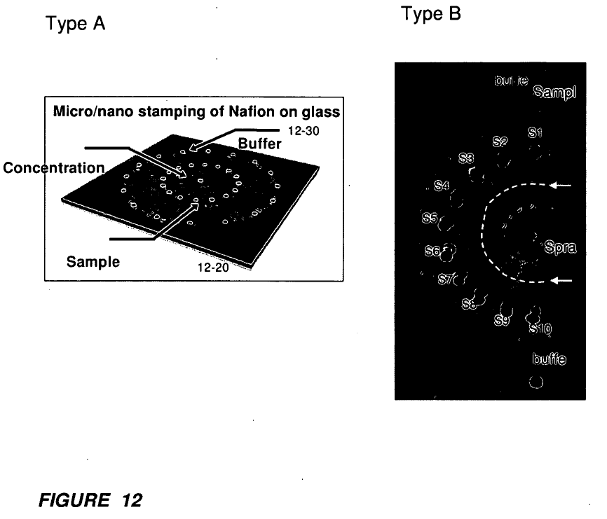

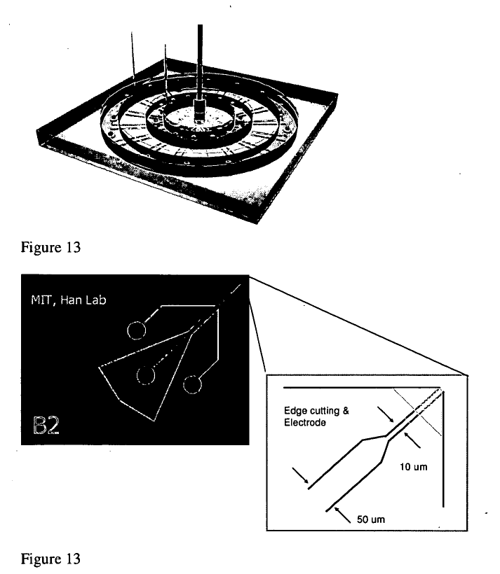

The devices as described herein may be fabricated of inexpensive material, and simply, such that the devices offer the potential of being disposable. In addition, the fabrication of the devices of this invention lends itself to the creation of parallel arrays of micro- and nano-fluidic devices comprising the integrated ion-selective membranes (FIG. 12). Such disposable, planar arrays for concentration of a desired solute find application in multiple settings, for example in high throughput screens, for various diagnostic and analytic applications (FIG. 13). For example, such arrays are amenable to integration in mass spectrometry. Such technology lends itself to the construction of integrated microfluidic chips for sample preparation, concentration and analysis, in some embodiments of this invention.

### Example 6

### An Alternative Fabrication Method for Making a Perm-Selective Junction

Instead of creating a planar ion-selective junction between the sample and side buffer channels by patterning the Nafion resin as disclosed herein above, an alternative way of creating an ion-selective membrane between the microchannels was developed. Using this fabrication method, a high-aspect-ratio ion-selective membrane was fabricated for enhanced sample preconcentration. The capillary-force-based filling method is shown in FIG. 18.

Initially, the Nafion resin was flown into the side buffer channels and filled the funnel-type junctions between the channels with liquid Nafion resin (FIG. 18a). The junction was typically 10-50 um wide in the opening and 20-50 um long. When filling the channels, the Nafion resin filled the junction and did not flow into the sample channel due to the surface tension. Then, the Nafion resin was removed by applying a negative pressure on the other end of the buffer channel to clear the channel (FIG. 18b). After removing the excess Nafion resin out of the buffer channels and once the main components of the Nafion resin such as water and alcohol have been evaporated completely, the Nafion resin trapped in the junction formed an ion-selective membrane between the channels (FIG. 18c). The whole device was heated up to 95° C. on a hotplate and was ready to use after 30 min (FIG. 18d). To increase the bonding strength between the Nafion membrane and the device, the surface of the device was treated with the Prime Coat first and then the channels were filled with Nafion resin, as described herein above. In one embodiment, this filling method can be applied to any ion-selective resins available in a liquid form as well as to colloidal particles in suspension with surface charge or a combination thereof.

It will be understood by those skilled in the art that various changes in form and details may be made therein without departing from the spirit and scope of the invention as set forth in the appended claims. Those skilled in the art will recognize, or be able to ascertain using no more than routine experimentation, many equivalents to the specific embodiments of the invention described herein. Such equivalents are intended to be encompassed in the scope of the claims.

In the claims articles such as “a,”, “an” and “the” mean one or more than one unless indicated to the contrary or otherwise evident from the context. Claims or descriptions that include “or” or “and/or” between members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides, in various embodiments, all variations, combinations, and permutations in which one or more limitations, elements, clauses, descriptive terms, etc., from one or more of the listed claims is introduced into another claim dependent on the same base claim unless otherwise indicated or unless it would be evident to one of ordinary skill in the art that a contradiction or inconsistency would arise. Where elements are presented as lists, e.g., in Markush group format or the like, it is to be understood that each subgroup of the elements is also disclosed, and any element(s) can be removed from the group.

It should it be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in haec verba herein.

Certain claims are presented in dependent form for the sake of convenience, but Applicant reserves the right to rewrite any dependent claim in independent format to include the elements or limitations of the independent claim and any other claim(s) on which such claim depends, and such rewritten claim is to be considered equivalent in all respects to the dependent claim in whatever form it is in (either amended or unamended) prior to being rewritten in independent format.

What is claimed is:

1. A concentrating device comprising:
a fluidic chip comprising a planar array of channels through which a liquid comprising a species of interest can be made to pass;
at least one rigid substrate connected thereto such that at least a portion of a surface of said substrate bounds said channels;
an ion-selective membrane attached to at least a portion of said surface of said substrate, which bounds said channels; or
an ion-selective membrane which bounds a portion of a surface of one of said channels;
a unit to induce an electric field in said channel; and
a unit to induce an electrokinetic or pressure driven flow in said channel.

2. The device of claim 1, wherein said means for inducing an electric field in said channel is a voltage supply.

3. The device of claim 3, wherein said voltage applied by said voltage supply is between 50 mV and 1500 V.

4. The device of claim 3, wherein said voltage supply applies equal voltage to opposing sides of said microchannel.

5. The device of claim 3, wherein said voltage supply applies greater voltage to the anodic side of said channel, as compared to the cathodic side.

6. The device of claim 1, wherein the width of said channel is between 0.1-500 μm.

7. The device of claim 6, wherein the width of said channel is between 10 μm-200 μm

8. The device of claim 1, wherein the depth of said channel is between 0.5-200 μm.

9. The device of claim 8, wherein the depth of said channel is between 5-50 μm.

10. The device of claim 1, wherein said rigid substrate comprises pyrex, silicon, silicon dioxide, silicon nitride, quartz, PMMA, PC, acryl or COC (cyclic olefin copolymer).

11. The device of claim 1, wherein said fluidic chip comprises polydimethylsiloxane.

12. The device of claim 1, wherein said ion-selective membrane comprises polytetrafluoroethylenes (PTFEs), polyphosphazenes, polybenzimidazoles (PBIs), poly-zirconia, polyethyleneimine-poly(acrylic acid), perfluorosulfonates, non-fluorinated hydrocarbon polymers, polymer-inorganic composites or poly(ethylene oxide).

13. The device of claim 1, wherein said ion-selective membrane has a width of 50-1000 μm.

14. The device of claim 1, wherein said ion-selective membrane has a width of 100-500 nanometers.

15. The device of claim 1, wherein said ion-selective membrane has a depth of 100-500 nanometers.

16. The device of claim 1, wherein a surface of said microchannel has been functionalized to reduce or enhance adsorption of said species of interest to said surface.

17. The device of claim 1, wherein the surface of the microchannel has been functionalized to enhance or reduce the operation efficiency of the device.

18. The device of claim 1, wherein said unit to induce an electric field in said channel comprises at least a pair of electrodes and a power supply.

19. The device of claim 1, wherein said device is coupled to a separation system, detection system, analysis system or combination thereof.

20. The device of claim 1, wherein the device is coupled to a mass spectrometer.

21. A method of concentrating a species of interest in a liquid, the method comprising applying a liquid comprising said species of interest to the device of claim 1.

22. The method of claim 21, further comprising the steps of:
inducing an electric field in said channel whereby ion depletion occurs in a region in said channel proximal to said ion-selective membrane, and a space charge layer is formed within said channel, which provides an energy barrier to said species of interest; and
inducing liquid flow in said channel.

23. The method of claim 22, wherein said flow is electroosmotic.

24. The method of claim 22, wherein said flow is pressure driven.

25. The method of claim 22, wherein steps are carried out cyclically.

26. The method of claim 22, wherein inducing an electric field in said channel is by applying voltage to said device.

27. The method of claim 26, wherein said voltage is between 50 mV and 1500 V.

28. The method of claim 26, wherein equal voltage is applied to opposing sides of said channel.

29. The method of claim 26, wherein greater voltage is applied to the anodic side of said channel, as compared to the cathodic side.

30. The method of claim 29, wherein a space charge layer is generated in said channel prior to applying said greater voltage to said anodic side of said channel.

31. The method of claim 22, wherein said liquid comprises an organ homogenate, cell extract or blood sample.

32. The method of claim 22, wherein said species of interest comprises proteins, polypeptides, nucleic acids, viral particles, or combinations thereof.

33. The method of claim 22, wherein said device is coupled to a separation system, detection system, analysis system or combination thereof.

34. A method for the preparation of a concentrating device comprising:
a fluidic chip comprising a planar array of channels through which a liquid comprising a species of interest can be made to pass;
at least one rigid substrate connected thereto such that at least a portion of a surface of said substrate bounds said channels; and
an ion-selective membrane bonded to at least a portion of said surface of said substrate, which bounds said channels;
said method comprising
applying a liquid polymer to a rigid substrate under negative pressure wherein said substrate is connected to a fluidic chip comprising channels such that said channels bound at least a portion of a surface of said substrate and whereby said polymer is applied for a time sufficient to form a layer of said polymer on a surface of said substrate;
providing conditions such that said liquid polymer layer forms a membranous structure on a surface of said substrate; and
attaching said substrate to said fluidic chip comprising channels such that said channels bound at least a portion of a surface of said substrate comprising said membranous structure.

35. The method of claim 34, wherein said fluidic chip comprises channels having a width of between 10-200 μm.

36. The method of claim 34, wherein said fluidic chip comprises channels having a depth of between 5-50 μm.

37. The method of claim 34, wherein said membranous structure has a width of between about 50-1000 μm.

38. The method of claim 34, wherein said membranous structure has a depth of between about 100-500 nm.

39. The method of claim 34, wherein said membranous structure has a depth of between about 1-50 μm.

40. The method of claim 34, wherein said rigid substrate comprises pyrex, silicon, silicon dioxide, silicon nitride, quartz, PMMA, PC or acryl.

41. The method of claim 34, wherein said fluidic chip comprises polydimethylsiloxane.

42. The method of claim 34 wherein said liquid polymer comprises polytetrafluoroethylenes, polyphosphazenes, polybenzimidazoles (PBIs), poly-zirconia, polyethyleneimine-poly(acrylic acid), or poly(ethylene oxide)-poly(acrylic acid).

43. The method of claim 34, wherein providing conditions such that said liquid polymer layer forms a membranous structure on a surface of said substrate is accomplished by heating said substrate.

44. The method of claim 34, wherein attaching said substrate to said fluidic chip is by plasma bonding.

45. A method for the preparation of a concentrating device comprising:
a fluidic chip comprising a planar array of channels through which a liquid comprising a species of interest can be made to pass;
at least one rigid substrate connected thereto such that at least a portion of a surface of said substrate bounds said channels; and
an ion-selective membrane bonded to at least a portion of said surface of said substrate, which bounds said channels;
said method comprising
stamping a liquid polymer on a rigid substrate in a desired geometry, pattern or a combination thereof, whereby said polymer is applied for a time sufficient to form a layer of said polymer on a surface of said substrate;
providing conditions such that said liquid polymer layer forms a membranous structure on a surface of said substrate; and
attaching said substrate to a fluidic chip comprising channels such that said channels bound at least a portion of a surface of said substrate comprising said membranous structure.

46. The method of claim 45, wherein the thickness of said membranous structure may be enhanced by increasing the viscosity of said liquid polymer.

47. The method of claim 45, wherein the thickness of said membranous structure may be enhanced by using a hydrophobic stamper for said stamping.

48. The method of claim 45, wherein said stamping is accomplished with a stamper comprising polydimethylsiloxane.

49. The method of claim 45, wherein said fluidic chip comprises channels having a width of between 10-200 μm.

50. The method of claim 45, wherein said fluidic chip comprises channels having a depth of between 5-50 μm.

51. The method of claim 45, wherein said membranous structure has a width of between about 50-1000 μm.

52. The method of claim 45, wherein said membranous structure has a depth of between about 100-500 nm.

53. The method of claim 45, wherein said membranous structure has a depth of between about 1-50 μm.

54. The method of claim 51, wherein said rigid substrate comprises pyrex, silicon, silicon dioxide, silicon nitride, quartz, PMMA, PC or acryl.

55. The method of claim 45, wherein said fluidic chip comprises polydimethylsiloxane.

56. The method of claim 45, wherein said liquid polymer comprises polytetrafluoroethylenes, polyphosphazenes, polybenzimidazoles (PBIs), poly-zirconia, polyethyleneimine-poly(acrylic acid), or poly(ethylene oxide)-poly(acrylic acid).

57. The method of claim 45, wherein providing conditions such that said liquid polymer layer forms a membranous structure on a surface of said substrate is accomplished by heating said substrate.

58. The method of claim 45, wherein attaching said substrate to said fluidic chip is by plasma bonding.

59. The method of claim 45, wherein the polymer is introduced to the substrate using ink-jet instead of stamping.

60. A method for the preparation of a concentrating device comprising:
a fluidic chip comprising a planar array of channels through which a liquid comprising a species of interest can be made to pass;
at least one rigid substrate connected thereto such that at least a portion of a surface of said substrate bounds said channels; and
a high aspect ratio ion-selective membrane which bounds a portion of a surface of one of said channels;
said method comprising:
applying a liquid polymer to at least a portion of one of said channels whereby said polymer is applied for a time sufficient to form a layer of said polymer on a portion of a surface of one of said channels; and
providing conditions such that said liquid polymer layer forms a membranous structure;

61. The method of claim 60, wherein said liquid polymer comprises microbeads or polyelectrolyte or a combination thereof, which are infiltrated with or prior to said liquid polymer.

62. The method of claim 60, wherein said liquid polymer is an ion-selective resin.

63. The method of claim 60, wherein said liquid polymer is liquid Nafion.

64. The method of claim 60, wherein said providing conditions step comprises the formation of a Nafion membrane by first introducing Nafion resin into a trench in said rigid substrate.

65. The method of claim 64, wherein said trench is formed with the desired membrane dimensions.

66. The method of claim 60, wherein said providing conditions step comprises capillary-force-based filling of said liquid polymer.
